(19) United States
(12) Patent Application Publication
(10) Pub. No.: US 2026/0149401 A1
(43) Pub. Date: May 28, 2026

(54) TECHNIQUE FOR CONTROLLING BRUSHLESS MOTOR OF ELECTRIC WORK MACHINE

(71) Applicant: MAKITA CORPORATION, Anjo-shi (JP)

(72) Inventor: Masayuki OKAMURA, Anjo-shi (JP)

(73) Assignee: MAKITA CORPORATION, Anjo-shi (JP)

(21) Appl. No.: 19/177,815

(22) Filed: Apr. 14, 2025

(30) Foreign Application Priority Data
Apr. 18, 2024 (JP) 2024-067589

(51) Int. Cl. H02P 23/28

(52) U.S. Cl. CPC H02P 23/28

(57) ABSTRACT

One aspect of the present disclosure provides an electric work machine including a brushless motor, multiple positive-side conduction paths, multiple negative-side conduction paths, multiple high-side switches, multiple low-side switches, and a control circuit. The control circuit performs a conduction control and a current-delivery restriction. The conduction control includes turning on a driven pair according to a first conduction pattern each time an update timing arrives. The current-delivery restriction includes suspending the conduction control to thereby restrict or stop delivery of an electric power to the brushless motor, based on elapse of a limit time without arrival of a next update timing since arrival of the update timing.

### CROSS-REFERENCE TO RELATED APPLICATIONS

This application claims the benefit of Japanese Patent Application No. 2024-067589 filed on Apr. 18, 2024 with the Japan Patent Office, the entire disclosure of which is incorporated herein by reference.

### BACKGROUND

The present disclosure relates to an electric work machine including a brushless motor.

Japanese Unexamined Patent Application Publication No. 2023-31617 discloses an electric work machine including a brushless motor. In this electric work machine, a PWM control and a conduction angle control are used to control the brushless motor.

In the PWM control, each time the brushless motor rotates by a specified rotation angle, a switching element (hereinafter referred to as a “drive switch”) is selected, and a duty ratio is set. The duty ratio is set so that the brushless motor rotates at a desired rotational frequency. The drive switch is driven (i.e., turned on and off) according to the duty ratio.

In the conduction angle control, an ON-period of the drive switch is set so that the brushless motor rotates at the desired rotational frequency. The ON-period corresponds to a rotation angle (i.e., a conduction angle) at which the brushless motor should be turned on. The drive switch is turned on according to the conduction angle (i.e., continuously during the ON-period).

### SUMMARY

In the conduction angle control, periodic switching of the switching elements, as performed in the PWM control, is unnecessary. Thus, the switching elements are switched fewer in the conduction angle control than in the PWM control. This enables reduction of a power loss in the switching elements in the conduction angle control to thereby inhibit heat generation in the switching elements (and furthermore, heat generation in the motor drive system).

However, when a heavy-load work is performed, (i) the rotational frequency of the brushless motor decreases, (ii) whereby a period required for the brushless motor to rotate by the specified rotation angle becomes longer, and (iii) whereby the ON-time period of the drive switch also becomes longer. When the ON-time period of the drive switch becomes longer, a peak value of an electric current flowing through the brushless motor may increase. Such increase in the peak value may lead to a failure of the switching element and/or demagnetization of a magnet in the brushless motor.

In one aspect of the present disclosure, it is desirable, in an electric work machine, to be able to inhibit an increase in a peak value of an electric current flowing through a brushless motor when a rotational frequency of the brushless motor decreases due to a heavy load.

In the present disclosure, ordinal numbers such as “first” and “second” are just intended to distinguish elements from each other, and are not intended to limit the order or number of the elements. Therefore, the first element may be referred to as the second element, and similarly, the second element may be referred to as the first element. In addition, the first element may be provided without the second element, and similarly, the second element may be provided without the first element.

One aspect of the present disclosure provides an electric work machine including a brushless motor, multiple positive-side conduction paths, multiple negative-side conduction paths, multiple high-side switches, multiple low-side switches, and a control circuit.

The brushless motor (i) includes multiple terminals and (ii) is configured to drive a driven tool. The driven tool is fixed to the electric work machine or configured to be detachably attached to the electric work machine.

The multiple positive-side conduction paths each electrically couple a corresponding one of the multiple terminals to a positive electrode of a DC power source. The multiple negative-side conduction paths each electrically couple a corresponding one of the multiple terminals to a negative electrode of the DC power source.

The multiple high-side switches are each (i) on a corresponding one of the multiple positive-side conduction paths and (ii) configured to complete or interrupt the corresponding one of the multiple positive-side conduction paths. The multiple low-side switches are each (i) on a corresponding one of the multiple negative-side conduction paths and (ii) configured to complete or interrupt the corresponding one of the multiple negative-side conduction paths.

The control circuit is configured to perform a conduction control and a current-delivery restriction.

The conduction control includes, each time an update timing arrives, turning on a driven pair corresponding to a rotation angle of the brushless motor according to a first conduction pattern to thereby deliver a first electric power to the brushless motor from the DC power source through the driven pair. The update timing arrives each time the brushless motor rotates by a reference rotation angle. The driven pair includes two switches. The two switches are one of the multiple high-side switches and one of the multiple low-side switches.

The current-delivery restriction includes suspending the conduction control based on occurrence of a first abnormality during performance of the conduction control to thereby restrict or stop delivery of the first electric power to the brushless motor.

The first abnormality includes elapse of a limit time without arrival of a next update timing since arrival of the update timing.

As described above, the control circuit selects the driven pair each time the brushless motor rotates by the reference rotation angle. The control circuit turns on the selected driven pair according to the first conduction pattern to thereby deliver the first electric power to the brushless motor. When the rotational frequency of the brushless motor decreases, a time period (hereinafter referred to as a “reference rotation time” (or a conduction control time)) required for the brushless motor to rotate by the reference rotation angle becomes longer.

To cope with this, the control circuit performs the current-delivery restriction based on the elapse of the limit time without arrival of a next update timing since arrival of the update timing.

Therefore, with the electric work machine of the present disclosure, even when the rotational frequency of the brushless motor decreases during a heavy-load work to render the reference rotation time longer, the increase in the peak value of the electric current flowing through the brushless motor can be inhibited. This results in inhibiting a failure in the driven pair and demagnetization of the magnet in the brushless motor during the heavy-load work.

Another aspect of the present disclosure provides a method for controlling a brushless motor of an electric work machine, the method comprising:
driving a driven pair corresponding to a rotation angle of the brushless motor according to a conduction pattern each time an update timing arrives, the update timing arriving each time the brushless motor rotates by a reference rotation angle, the driven pair including, of multiple switches, two switches corresponding to the rotation angle, the multiple switches each being on a corresponding one of multiple conduction paths electrically coupling the brushless motor to a DC power source; and
suspending driving of the driven pair according to the conduction pattern based on a limit time having elapsed without arrival of a next update timing since arrival of the update timing.

By controlling the brushless motor through such a method, even when the rotational frequency of the brushless motor decreases due to a heavy-load work or the like, the increase in the peak value of the electric current flowing through the brushless motor can be inhibited. This results in inhibiting a failure in the driven pair and demagnetization of the magnet in the brushless motor during the heavy-load work.

### BRIEF DESCRIPTION OF THE DRAWINGS

Example embodiments of the present disclosure will be described below with reference to the accompanying drawings, in which:

FIG. 1 is a perspective view of an electric work machine of a first embodiment;

FIG. 2 is a block diagram showing an electrical configuration of the electric work machine;

FIG. 3 is a time chart showing operation of a control circuit during a no-load operation;

FIG. 4 is a time chart showing operation of the control circuit during a heavy-load operation;

FIG. 5 is a time chart showing operation of the control circuit at detection of a motor lock;

FIG. 6 is a flow chart of a main control process executed by the control circuit;

FIG. 7 is a flow chart of a timer interrupt handling for a main loop executed by the control circuit;

FIG. 8 is a flow chart of a timer interrupt handling for commutation executed by the control circuit;

FIG. 9 is a flow chart of a rotation detection process executed by the control circuit;

FIG. 10 is a flow chart of a switch operation detection process executed by the control circuit;

FIG. 11 is a flow chart of a motor lock detection process executed by the control circuit;

FIG. 12 is a flow chart of a motor control process executed by the control circuit;

FIG. 13 is a flow chart of a display process executed by the control circuit;

FIG. 14 is a time chart showing operation of the control circuit during a heavy-load operation in a second embodiment;

FIG. 15 is a flow chart of a timer interrupt handling for a main loop of the second embodiment;

FIG. 16 is a time chart showing operation of the control circuit during a heavy-load operation in a third embodiment;

FIG. 17 is a flow chart of a timer interrupt handling for a main loop of the third embodiment;

FIG. 18 is a time chart showing operation of the control circuit during a heavy-load operation in a fourth embodiment;

FIG. 19 is a flow chart of a timer interrupt handling for a main loop of the fourth embodiment; and

FIG. 20 is a time chart of a control operation of the control circuit under heavy load in a fifth embodiment.

### DETAILED DESCRIPTION OF EXEMPLARY EMBODIMENTS

### 1. Overview of Embodiments

One embodiment may provide an electric work machine including at least any one of the following features 1 through 22:
Feature 1: A brushless motor (or a brushless DC motor).
Feature 2: The brushless motor includes multiple terminals.
Feature 3: The brushless motor is configured to drive (e.g., rotate) a driven tool (or a driven object).
Feature 4: The driven tool is fixed to the electric work machine or configured to be detachably attached to the electric work machine.
Feature 5: Multiple positive-side conduction paths.
Feature 6: The multiple positive-side conduction paths each electrically couple a corresponding one of the multiple terminals to a positive electrode of a DC power source.
Feature 7: Multiple negative-side conduction paths.
Feature 8: The multiple negative-side conduction paths each electrically couple a corresponding one of the multiple terminals to a negative electrode of the DC power source.
Feature 9: Multiple high-side switches.
Feature 10: The multiple high-side switches are each on a corresponding one of the multiple positive-side conduction paths.
Feature 11: The multiple high-side switches are each configured to complete or interrupt the corresponding one of the multiple positive-side conduction paths.
Feature 12: Multiple low-side switches.
Feature 13: The multiple low-side switches are each on a corresponding one of the multiple negative-side conduction paths.
Feature 14: The multiple low-side switches are each configured to complete or interrupt the corresponding one of the multiple negative-side conduction paths.
Feature 15: A control circuit (or a controller).
Feature 16: The control circuit is configured to perform a conduction control (or a current-delivery control).
Feature 17: The conduction control includes, each time an update timing arrives, turning on a driven pair (or a pair of driven switches) corresponding to a rotation angle of the brushless motor according to a first conduction pattern to thereby deliver a first electric power to the brushless motor from the DC power source through the driven pair. The brushless motor may be configured to be driven (i.e., to rotate) by receiving the first electric power. The first conduction pattern may be determined in advance.
Feature 18: The update timing arrives each time the brushless motor rotates by a reference rotation angle.
Feature 19: The driven pair includes two switches. The two switches are one of the multiple high-side switches and one of the multiple low-side switches.
Feature 20: The control circuit is configured to perform a current-delivery restriction (or a conduction restriction).
Feature 21: The current-delivery restriction includes suspending (or stopping) the conduction control based on occurrence of a first abnormality (or a first anomaly) during performance of the conduction control to thereby restrict or stop delivery of the first electric power to the brushless motor.
Feature 22: The first abnormality includes elapse of a limit time without arrival of a next update timing since arrival of the update timing.

In the electric work machine including at least the features 1 through 22, even when the rotational frequency of the brushless motor decreases during a heavy-load work to render a reference rotation time longer, the increase in the peak value of the electric current flowing through the brushless motor can be inhibited. The reference rotation time corresponds to a time period required for the brushless motor to rotate by the reference rotation angle.

Therefore, a failure in the driven pair and demagnetization of the magnet in the brushless motor during the heavy-load work are inhibited.

The rotational frequency (i) refers to a number of rotations per unit of time and (ii) is synonymous with a rotational speed. Therefore, the rotational frequency may also be referred to as a rotational speed.

The brushless motor may be in the form of a three-phase brushless DC motor. The multiple terminals may be three terminals.

The multiple positive-side conduction paths may be three positive-side conduction paths. The multiple negative-side conduction paths may be three negative-side conduction paths. The DC power source may include a battery. The battery may be a rechargeable battery. The electric work machine may incorporate therein the battery or may be configured such that the battery is detachably attached to the electric work machine. The “conduction path” may be reworded by “current path”.

Each of the multiple high-side switches and each of the multiple low-side switches may be a semiconductor switch. Examples of the semiconductor switch include a field-effect transistor (FET), a bipolar transistor, and an insulated gate bipolar transistor (IGBT).

The multiple high-side switches may be three high-side switches. The multiple low-side switches may be three low-side switches. Specifically, the electric work machine may include a full-bridge circuit. The full-bridge circuit includes the three high-side switches and the three low-side switches.

The first conduction pattern may include maintaining the driven pair to be ON for a specific time period until the brushless motor rotates by a specific angle. The specific angle may be the same as the reference rotation angle or may be smaller than the reference rotation angle. The first conduction pattern may include periodically turning on and off at least one of the two switches in the driven pair repeatedly until the brushless motor rotates by the specific angle.

The reference rotation angle may be 60 electrical degrees, for example.

The first electric power may be equal to a maximum electric power that the DC power source can supply or may be smaller than the maximum electric power.

The current-delivery restriction may include delivering an electric power smaller than the first electric power to the brushless motor or stopping delivery of the electric power from the DC power source to the brushless motor.

The control circuit may be configured to detect rotation of the brushless motor by the reference rotation angle. The control circuit may detect (or determine) arrival of the update timing based on the detection of the rotation of the brushless motor by the reference rotation angle.

The driven pair may be set in advance according to the rotation angle of the brushless motor.

Examples of the driven tool include various tool bits, blades (e.g., a rotary blade, a mowing blade, a saw blade, and a planning blade), and grindstones.

One embodiment may include the following feature 23 in addition to or in place of at least any one of the features 1 through 22.
Feature 23: The control circuit is configured to resume (or restart, or proceed with) the conduction control based on arrival of the update timing during performance of the current-delivery restriction.

In the electric work machine including at least the features 1 through 23, even when the current-delivery restriction is performed during the heavy-load work, the conduction control can be resumed based on arrival of the next update timing.

Therefore, during the heavy-load work as well, the brushless motor can be driven continuously while inhibiting the increase in the peak value of the electric current flowing through the brushless motor.

One embodiment may include the following feature 24 in addition to or in place of at least any one of the features 1 through 23.
Feature 24: The control circuit is configured to resume the conduction control based on elapse of a standby time since start of the current-delivery restriction.

The standby time may be set in advance.

In the electric work machine including at least the features 1 through 22 and 24, even when the current-delivery restriction is performed during the heavy-load work, the conduction control is resumed upon the elapse of the standby time.

Therefore, during the heavy-load work as well, the brushless motor can be driven continuously while inhibiting the increase in the peak value of the electric current flowing through the brushless motor.

One embodiment may include the following feature 25 in addition to or in place of at least any one of the features 1 through 24.
Feature 25: The control circuit is configured to resume the conduction control based on the standby time having elapsed without arrival of the update timing since the start of the current-delivery restriction.

One embodiment may include the following feature 26 in addition to or in place of at least any one of the features 1 through 25.
Feature 26: The current-delivery restriction includes turning off the multiple high-side switches and the multiple low-side switches to thereby stop delivery of an electric power of the DC power source to the brushless motor.

In the electric work machine including at least the features 1 through 22 and 26, upon the elapse of the limit time since the update timing, the current-delivery to the brushless motor is interrupted through the current-delivery restriction. Thus, a failure in the driven pair and demagnetization of the magnet in the brushless motor due to the electric current flowing through the brushless motor are further inhibited.

One embodiment may include at least any one of the following features 27 and 28 in addition to or in place of at least any one of the features 1 through 26.
Feature 27: The current-delivery restriction includes delivering a second electric power to the brushless motor from the DC power source through the driven pair.
Feature 28: The second electric power is smaller than the first electric power.

One embodiment may include at least any one of the following features 29 through 31 in addition to or in place of at least any one of the features 1 through 28.
Feature 29: The current-delivery restriction includes driving the driven pair according to a second conduction pattern to thereby deliver the second electric power to the brushless motor.
Feature 30: The second conduction pattern is different from the first conduction pattern.
Feature 31: The second conduction pattern includes periodically turning on and off at least one of the two switches in the driven pair repeatedly.

In the electric work machine including at least the features 1 through 22 and 27 through 31, the second electric power is delivered to the brushless motor even during the current-delivery restriction. Thus, a failure in the driven pair and demagnetization of the magnet in the brushless motor due to the electric current flowing through the brushless motor are inhibited. In addition, the rotation of the brushless motor is inhibited from being stopped in a period before the conduction control is resumed is inhibited.

One embodiment may include at least any one of the following features 32 through 35 in addition to or in place of at least any one of the features 1 through 31.
Feature 32: A drive circuit (or a drive system for the brushless motor).
Feature 33: The drive circuit includes the multiple high-side switches and the multiple low-side switches.
Feature 34: The drive circuit is configured to deliver an electric power of the DC power source to the brushless motor.
Feature 35: An amount of heat generated from the drive circuit in response to delivery of the second electric power to the brushless motor is smaller than an amount of heat generated from the drive circuit in response to the delivery of the first electric power to the brushless motor.

In the electric work machine including at least the features 1 through 22, 27, 28, and 32 through 35, a situation is inhibited in which, during performance of the current-delivery restriction, the amount of heat generated from the drive circuit increases. to cause a failure in the drive circuit.

One embodiment may include the following feature 36 in addition to or in place of at least any one of the features 1 through 35.
Feature 36: The control circuit is configured to perform a first notification based on start of the current-delivery restriction.

The first notification may correspond to notifying a user that the current-delivery restriction is being performed and/or that the first abnormality has occurred.

One embodiment may include the following feature 37 in addition to or in place of at least any one of the features 1 through 36.
Feature 37: The control circuit is configured to continue the first notification until the conduction control is resumed, based on the start of the current-delivery restriction.

In the electric work machine including at least the features 1 through 22, 36, and 37, the user of the electric work machine can be notified that the first abnormality has occurred and/or that the current-delivery restriction is being performed. The user can recognize, based on the first notification, that a protection function of the electric work machine is being operated (i.e., that the current-delivery restriction is being performed).

One embodiment may include at least any one of the following features 38 through 41 in addition to or in place of at least any one of the features 1 through 37.
Feature 38: The control circuit is configured to stop delivery of an electric power of the DC power source to the brushless motor based on occurrence of a second abnormality (or a second anomaly) in the electric work machine.
Feature 39: The second abnormality is different from the first abnormality.
Feature 40: The control circuit is configured to perform a second notification based on occurrence of the second abnormality in the electric work machine.
Feature 41: The second notification is different from the first notification.

In the electric work machine including at least the features 1 through 22 and 36 through 41, the user can recognize the second abnormality in addition to the first abnormality. Thus, the user can understand the cause of the abnormality (or anomaly) in the electric work machine.

One embodiment may include at least any one of the following features 42 through 44 in addition to or in place of at least any one of the features 1 through 41.
Feature 42: The second abnormality includes elapse of a protection determination time without arrival of the update timing since the start of the current-delivery restriction.
Feature 43: The protection determination time is longer than the standby time.
Feature 44: The second abnormality includes rotation of the driven tool being forcibly stopped by an object different from the electric work machine to thereby lock the brushless motor (i.e., stop the rotation of the brushless motor).

The brushless motor may be locked based on the driven tool coming in contact with such a different object (e.g., an obstacle).

One embodiment may include at least any one of the following features 45 through 47 in addition to or in place of at least any one of the features 1 through 44.
Feature 45: The conduction control includes a conduction angle control. Turning on the driven pair according to the first conduction pattern may include the conduction angle control.
Feature 46: The conduction angle control includes setting (or controlling) a conduction angle such that a rotational frequency of the brushless motor is consistent with (or becomes the same as) a desired rotational frequency (or a target rotational frequency).
Feature 47: The conduction angle control includes maintaining the driven pair to be ON from start of the conduction control until the brushless motor rotates by a rotation angle corresponding to the conduction angle.

One embodiment may include at least any one of the following features 48 through 50 in addition to or in place of at least any one of the features 1 through 47.
Feature 48: The conduction control includes a PWM control.
Feature 49: The PWM control includes setting a duty ratio such that a rotational frequency of the brushless motor is consistent with the desired rotational frequency. Turning on the driven pair according to the first conduction pattern may include the PWM control.
Feature 50: The PWM control includes periodically turning on and off at least one of the two switches in the driven pair repeatedly according to the duty ratio.

In the electric work machine including at least the features 1 through 22 and 45 through 47 and/or the electric work machine including at least the features 1 through 22 and 48 through 50, the current-delivery restriction is performed based on the limit time having elapsed since the update timing. Thus, the above-described effect can be obtained.

One embodiment may include at least any one of the following features 51 and 52 in addition to or in place of at least any one of the features 1 through 50.
Feature 51: A rotation angle detector configured to output a position detection signal corresponding to the rotation angle of the brushless motor.
Feature 52: The update timing arrives based on the position detection signal indicating that the brushless motor has rotated by a reference rotation angle.

In one embodiment, the control circuit may be integrated into a single electronic unit or a single electronic device or a single circuit board.

In one embodiment, the control circuit may be a combination of two or more electronic circuits or two or more electronic units or two or more electronic devices, which are individually provided on the electric work machine or within the electric work machine.

In one embodiment, the control circuit may include a microcomputer (or a microcontroller or a microprocessor), a wired logic, an application specific integrated circuit (ASIC), an application specific standard product (ASSP), a programmable logic device (e.g., a field programmable gate array (FPGA)), a discrete electronic component, and/or a combination thereof.

One embodiment may provide a method for controlling a brushless motor of an electric work machine, which method includes at least any one of the following features 53 and 54:
Feature 53: Driving a driven pair corresponding to a rotation angle of the brushless motor according to a conduction pattern each time an update timing arrives.

The update timing may arrive each time the brushless motor rotates by a reference rotation angle. The driven pair may include, of multiple switches, two switches corresponding to the rotation angle. The multiple switches may each be on a corresponding one of multiple conduction paths electrically coupling the brushless motor to a DC power source.
Feature 54: Suspending driving of the driven pair according to the conduction pattern based on a limit time having elapsed without arrival of a next update timing since arrival of the update timing.

With the method including at least the features 53 and 54, even when the rotational frequency of the brushless motor decreases during a heavy-load work to render the reference rotation time longer, the increase in the peak value of the electric current flowing through the brushless motor can be inhibited.

Examples of the electric work machine include various work machines that are used in job sites (or work sites) of architecture, manufacturing, civil engineering, construction, agriculture, horticulture, cleaning, do-it-yourself carpentry, and so on and that are configured such that the brushless motor is operated by receiving an electric power. The electric work machine may be configured to receive an AC power. In this case, the DC power source may be configured to (i) receive the AC power, (ii) generate a DC power from the AC power, and (iii) supply the DC power.

More specific examples of the electric work machine may include electric power tools for masonry work, metalworking, and woodworking, work machines for gardening, and devices for preparing an environment of job sites, and more specifically include electric blowers, electric hammers, electric hammer drills, electric drills, electric drivers, electric wrenches, electric grinders, electric circular saws, electric reciprocating saws, electric jig saws, electric cutters, electric chain saws, electric planes, electric nailing machines (including tackers), electric hedge trimmers, electric lawn mowers, electric lawn trimmers, electric bush/grass cutters, electric cleaners, electric sprayers, electric spreaders, electric dust collectors (or electric dust extractors), electric trowels, electric vibrators, electric rammers, electric compactors, electric pumps, electric pile drivers, electric concrete saws, electric screeds, electric cut-off saws, robot vacuum cleaners, battery-powered wheel barrows (or battery-powered dollies or battery-powered hand trucks), battery-powered bicycles, and fan vests.

In one embodiment, the above-described features 1 through 54 may be combined in any combinations.

In one embodiment, some of the above-described features 1 through 54 may be excluded.

### 2. Specific Example Embodiments

Example embodiments of the present disclosure will be described below with reference to the drawings.

### 2-1. First Embodiment

### [2-1-1. Mechanical Configuration of Electric Work Machine]

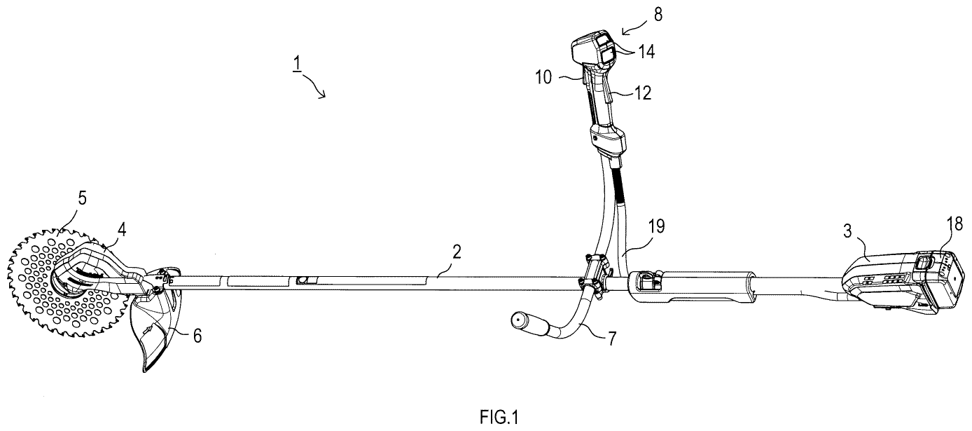

An example embodiment described below provides an electric work machine 1 shown in FIG. 1. The electric work machine 1 of this first embodiment is in the form of a grass cutter.

As shown in FIG. 1, the electric work machine 1 includes a main pipe 2, a control unit 3, a drive unit 4, and a handle 7. The main pipe 2 has a shape of an elongated and hollow rod. The control unit 3 is arranged on a rear-end side of the main pipe 2, and the drive unit 4 is arranged on a front-end side of the main pipe 2.

The drive unit 4 includes an output shaft (not shown). Attached to the output shaft detachably and rotatably is a rotary blade 5. The rotary blade 5 is used to cut an object to be cut. Examples of the object to be cut include grass and small-diameter trees. The rotary blade 5 shown in FIG. 1 is in the form of a so-called tipped saw. The rotary blade 5 is one example of the driven tool in Overview of Embodiments.

The rotary blade 5 of the first embodiment (i) is of metal, (ii) has a disk-like shape, and (iii) has serrated teeth formed over the entire outer circumference of the rotary blade 5. A hard tip is attached to a tip of each tooth.

The electric work machine 1 includes a cover 6 on the front-end side of the main pipe 2. The cover 6 inhibits the grass cut by the rotary blade 5, and so on, from flying toward a user (or an operator) of the electric work machine 1.

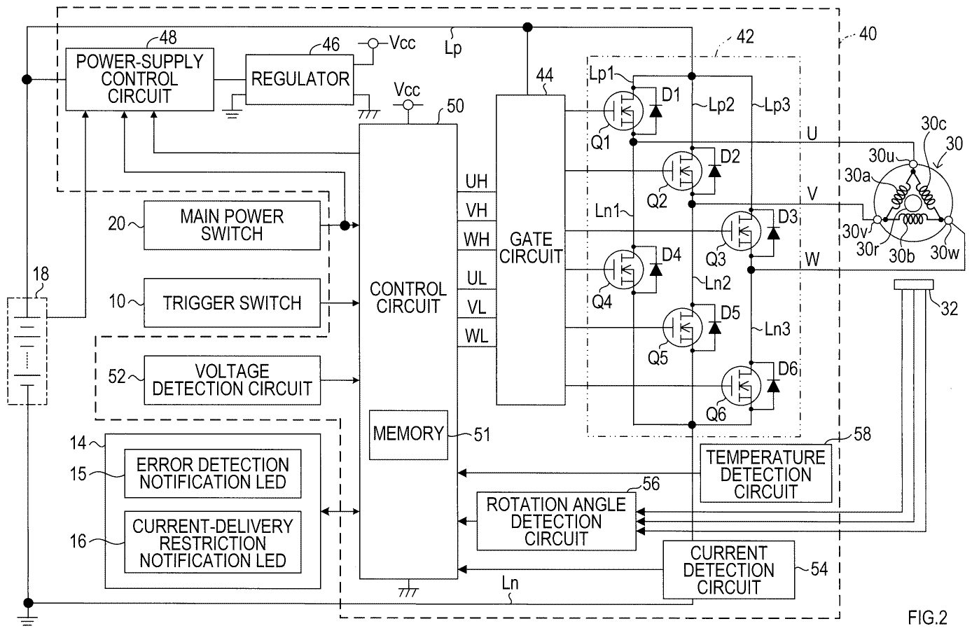

The drive unit 4 houses a motor 30 (see FIG. 2) and a gear mechanism (not shown). The motor 30 is a drive source for driving the rotary blade 5 to rotate. The gear mechanism is coupled directly or indirectly to the motor 30 and to the output shaft. The gear mechanism transmits the rotation of the motor 30 to the output shaft.

The motor 30 is in the form of a three-phase brushless motor (in more detail, three-phase brushless DC motor) of an interior permanent magnet (IPM) type. The control unit 3 houses a controller 40 (see FIG. 2). The motor 30 is driven and controlled by the controller 40.

The handle 7 is connected to the main pipe 2 at the vicinity of a longitudinally middle position of the main pipe 2. The user can use the electric work machine 1 while gripping the handle 7. In this first embodiment, the handle 7 is in the form of a so-called U-shaped handle and includes grips each arranged at a corresponding end of the handle 7. The handle 7 may be in the form different from the U-shaped handle (e.g., may be in the form of a loop handle).

The handle 7 is provided with an operation/display unit 8 on one of the grips (or in the vicinity thereof). The operation/display unit 8 may be arranged in any position on the handle 7 or may be arranged in a position different from that on the handle 7. The operation/display unit 8 is finger-operated by the user. The user can confirm an operation state of the electric work machine 1 through the operation/display unit 8. The operation/display unit 8 includes a trigger switch 10, a lock-off switch 12, and a display panel 14.

The display panel 14 displays (i) a rotation state of the motor 30, (ii) a remaining electric energy of a battery pack 18 (more specifically, of batteries housed in the battery pack 18), and so on. The display panel 14 includes an operation switch. The user can set a rotation direction of the motor 30 (i.e., of the rotary blade 5), and so on, through the operation switch.

The battery pack 18 is detachably attached to a rear end of the control unit 3. The battery pack 18 supplies a DC power to the control unit 3. The trigger switch 10 inputs a command to drive the motor 30 to the controller 40. The lock-off switch 12 places restrictions on operation of the trigger switch 10. The user can operate (specifically, pull or move) the trigger switch 10 while holding down the lock-off switch 12. The trigger switch 10 outputs a trigger signal while the trigger switch 10 is operated. The trigger signal is input to a control circuit 50.

The trigger switch 10 and the display panel 14 are electrically coupled to the controller 40 through a cable 19. In response to the user's operation of the trigger switch 10 and/or the display panel 14, the controller 40 (i) drives the motor 30, and/or (ii) switches the rotation direction of the motor 30, and/or (iii) displays various information on the display panel 14.

### [2-1-2. Electrical Configuration of Electric Work Machine]

An electrical configuration of the electric work machine 1 will be described with reference to FIG. 2. The electric work machine 1 includes the controller 40 within the control unit 3. The controller 40 includes the control circuit 50. A main power switch 20, and the trigger switch 10 and the display panel 14 described above are electrically coupled to the controller 40 (more specifically, to the control circuit 50). The controller 40 may be arranged in a portion different from the control unit 3.

The main power switch 20 is operated by the user to command the controller 40 to be activated or deactivated. The main power switch 20 of this first embodiment is a momentary switch and is normally opened. Each time the main power switch 20 is manually operated (e.g., pressed down) by the user, (i) a main power signal is input from the main power switch 20 to the control circuit 50, and (ii) in response to the main power signal, the control circuit 50 switches the controller 40 from an ON-state (or an activated state) to an OFF-state (or a deactivated state), and vice versa. The “ON-state” corresponds to a state of being normally operated. The “OFF-state” corresponds to a state of not being operated or of being operated with the function restricted as compared with that in the “ON-state”. The “ON-state” and the “OFF-state” of the controller 40 may be reworded respectively as an “ON-state” and an “OFF-state” of a main power state or may be reworded respectively as an “ON-state” and an “OFF-state” of the main power switch 20.

The display panel 14 includes two or more LEDs for displaying various states of the electric work machine 1. The two or more LEDs include a main power indicator LED (not shown). The main power indicator LED is turned on when the controller 40 is in the ON-state.

As shown in FIG. 2, the two or more LEDs include an error detection notification LED 15 and a current-delivery restriction notification LED 16. The error detection notification LED 15 is turned on when a second abnormality in the electric work machine 1 (e.g., lock of the motor 30) is detected. The current-delivery restriction notification LED 16 is turned on when a first abnormality occurs in the electric work machine 1. The first abnormality occurring includes a current-delivery restriction to be described below being performed. The turning-on of the current-delivery restriction notification LED 16 is one example of the first notification described in Overview of Embodiments. The turning-on of the error detection notification LED 15 is one example of the second notification described in Overview of Embodiments.

The motor 30 includes first through third windings 30a, 30b, and 30c, a rotor 30r, and first through third terminals 30u, 30v, and 30w. The first through third terminals 30u, 30v, and 30w respectively correspond to the U-phase, V-phase, and W-phase of the motor 30. The first through third windings 30a, 30b, and 30c are connected to each other in a delta configuration. The rotor 30r includes therein a not-shown permanent magnet. The first terminal 30u is connected to a first end of the first winding 30a and to a first end of the third winding 30c. The second terminal 30v is connected to a second end of the first winding 30a and to a first end of the second winding 30b. The third terminal 30w is connected to a second end of the second winding 30b and to a second end of the third winding 30c. In other embodiments, the motor 30 may be a brushless DC motor in any other form, such as a single-phase brushless DC motor, a two-phase brushless DC motor, and a brushless DC motor with four or more phases. In other embodiments, the first through third windings 30a, 30b, and 30c may be connected to each other in a star configuration (or a Y-configuration).

The electric work machine 1 includes a rotation sensor 32 around the rotor 30r. The rotation sensor 32 includes not-shown three Hall sensors arranged at intervals of 120 electrical degrees along a circumferential direction of the rotor 30r. These Hall sensors output first, second, and third Hall signals. The first, second, and third Hall signals respectively correspond to the U-phase, V-phase, and W-phase of the motor 30. Each of the first through third Hall signals is an analog signal, and its logical value is inverted each time the rotor 30r rotates by 180 electrical degrees. The first through third Hall signals are out of phase with each other by 120 electrical degrees.

The controller 40 is activated by receiving the DC power (hereinafter referred to as a “battery power”) from the battery pack 18, thus driving and controlling the motor 30.

The controller 40 includes a positive-side current path Lp. The positive-side current path Lp is coupled to a positive electrode of the battery pack 18 (and further to positive electrodes of the batteries). The controller 40 includes a negative-side current path Ln. The negative-side current path Ln is coupled to a negative electrode of the battery pack 18 (and further to negative electrodes of the batteries).

The controller 40 includes a drive circuit (or bridge circuit) 42, a gate circuit 44, a regulator 46, and a power-supply control circuit 48.

The drive circuit 42 (i) receives the battery power from the battery pack 18, (ii) generates a driving electric power for rotating the motor 30 (in more detail, for rotating the rotor 30r) from the battery power, and (iii) delivers the driving electric power to the motor 30. In this first embodiment, the drive circuit 42 is in the form of a three-phase full-bridge circuit. In other embodiments, the drive circuit 42 may be any bridge circuit other than the three-phase full-bridge circuit. In other embodiments, the drive circuit 42 may be arranged in the electric work machine 1 apart from the controller 40.

The drive circuit 42 includes, as so-called upper arms, first through third positive-side conduction paths Lp1, Lp2, and Lp3. The first through third positive-side conduction paths Lp1, Lp2, and Lp3 are configured to electrically couple the positive-side current path Lp to the first through third terminals 30u, 30v, and 30w of the motor 30, respectively, and to deliver a drive current (or a power-supply current) from the positive-side current path Lp to any one of the first through third terminals 30u, 30v, and 30w. The first through third positive-side conduction paths Lp1, Lp2, and Lp3 respectively include thereon first through third switches Q1, Q2, and Q3, as so-called high-side switches. The first through third positive-side conduction paths Lp1, Lp2, and Lp3 are completed or interrupted by the first through third switches Q1, Q2, and Q3, respectively.

The drive circuit 42 includes, as so-called lower arms, first through third negative-side conduction paths Ln1, Ln2, and Ln3. The first through third negative-side conduction paths Ln1, Ln2, and Ln3 are configured to electrically couple the negative-side current path Ln to the first through third terminals 30u, 30v, and 30w of the motor 30, respectively, and to deliver the drive current to the negative-side current path Ln from any one or two of the first through third terminals 30u, 30v, and 30w. The first through third negative-side conduction paths Ln1, Ln2, and Ln3 respectively include thereon fourth through sixth switches Q4, Q5, and Q6, as so-called low-side switches. The first through third negative-side conduction paths Ln1, Ln2, and Ln3 are completed or interrupted by the fourth through sixth switches Q4, Q5, and Q6, respectively. The “switches” in the first through sixth switches Q1, Q2, Q3, Q4, Q5, and Q6 may be reworded as “switch devices” or “switching elements”.

The first through sixth switches Q1, Q2, Q3, Q4, Q5, and Q6 are semiconductor switches. In this first embodiment, the first through sixth switches Q1, Q2, Q3, Q4, Q5, and Q6 are each in the form of an n-channel-type metal oxide semiconductor field effect transistor (MOSFET). Thus, the first through sixth switches Q1, Q2, Q3, Q4, Q5, and Q6 respectively incorporate therein first through sixth diodes D1, D2, D3, D4, D5, and D6 (so-called parasitic diodes or body diodes). More specifically, the first through sixth diodes D1, D2, D3, D4, D5, and D6 include respective cathodes connected to corresponding drains of the first through sixth switches Q1, Q2, Q3, Q4, Q5, and Q6. The first through sixth diodes D1, D2, D3, D4, D5, and D6 include respective anodes connected to corresponding sources of the first through sixth switches Q1, Q2, Q3, Q4, Q5, and Q6. In other embodiments, the first through sixth diodes D1, D2, D3, D4, D5, and D6 may be respectively provided to the first through sixth switches Q1, Q2, Q3, Q4, Q5, and Q6 in addition to or in place of the parasitic diodes or the body diodes.

Each of the first through sixth diodes D1, D2, D3, D4, D5, and D6 can bypass the drive current in a direction from the negative-side current path Ln to the positive-side current path Lp during a period in which the corresponding switch is turned off. In other embodiments, the first through sixth switches Q1, Q2, Q3, Q4, Q5, and Q6 may be semiconductor devices in any other form, such as bipolar transistors or insulated gate bipolar transistors (IGBTs).

The gate circuit 44 is electrically coupled to the positive electrode of the battery pack 18. The gate circuit 44 receives the voltage of the batteries (hereinafter referred to as a “battery voltage”) from the battery pack 18 and drives the first through sixth switches Q1, Q2, Q3, Q4, Q5, and Q6.

The regulator 46 receives the battery power through the power-supply control circuit 48. The regulator 46 generates an operating voltage Vcc from the battery power. In other words, the regulator 46 receives the battery voltage and converts (e.g., steps down) the battery voltage to the operating voltage Vcc. The operating voltage Vcc is a fixed DC voltage. Each part of the controller 40 operates with this operating voltage Vcc.

The power-supply control circuit 48 is electrically coupled to the positive electrode of the battery pack 18 to receive the battery power. When the controller 40 is in an ON-state, the power-supply control circuit 48 delivers the battery power to the regulator 46 to cause the regulator 46 to generate the operating voltage Vcc. The power-supply control circuit 48 may include an electric power path (not shown) for outputting the battery power to the regulator 46. The power-supply control circuit 48 may be configured to deliver the battery power to the regulator 46 by completing the electric power path.

The power-supply control circuit 48 is configured to receive (i) a first electric power shut-off signal from the battery pack 18 and/or (ii) a second electric power shut-off signal from the control circuit 50. The power-supply control circuit 48 delivering the battery power to the regulator 46 stops delivering the battery power to the regulator 46 based on the receipt of the first electric power shut-off signal and/or the second electric power shut-off signal. This stops the generation of the operating voltage Vcc by the regulator 46. The power-supply control circuit 48 may be configured to stop the delivery of the battery power to the regulator 46 by interrupting the electric power path.

The first electric power shut-off signal is output from the battery pack 18 when an abnormality in the battery pack 18 (e.g., a decrease in the battery voltage) is detected in the battery pack 18. The second electric power shut-off signal is output from the control circuit 50 when an abnormality in the electric work machine 1 is detected by the control circuit 50.

The control circuit 50 outputs first through sixth control signals UH, VH, WH, UL, VL, and WL to the gate circuit 44, and drives and controls the motor 30 through the gate circuit 44 and the drive circuit 42. The first through sixth control signals UH, VH, WH, UL, VL, and WL respectively correspond to the first through sixth switches Q1, Q2, Q3, Q4, Q5, and Q6. The gate circuit 44 turns on and off the first through sixth switches Q1, Q2, Q3, Q4, Q5, and Q6 according to the first through sixth control signals UH, VH, WH, UL, VL, and WL, respectively. A configuration may be employed in which the first through third control signals UH, VH, and WH are pulse-width modulation (PWM) signals and the fourth through sixth control signals UL, VL, and WL are non-PWM signals, and vice versa. Alternatively, all of the first through sixth control signals UH, VH, WH, UL, VL, and WL may be PWM signals. Based on one of the first through third switches Q1, Q2, and Q3 and one of the fourth through sixth switches Q4, Q5, and Q6 being turned on, the drive current is delivered to the motor 30 to cause the motor 30 to rotate.

The control circuit 50 of this first embodiment is in the form of a microcontroller unit (MCU) or a microcomputer including CPU, ROM, and RAM, which are not shown. In this first embodiment, the control circuit 50 includes a memory 51. The memory 51 stores a state (abnormal state or the like) of the motor 30 and/or the controller 40. The memory 51 of this first embodiment is in the form of a non-volatile memory in which the stored contents are electrically rewritable.

In other embodiments, in place of or in addition to the MCU, the control circuit 50 may include a discrete electronic component, a wired logic, an application specific integrated circuit (ASIC), an application specific standard product (ASSP), a programmable logic device (e.g., a field programmable gate array (FPGA)), and/or a combination thereof.

The controller 40 includes a voltage detection circuit (or voltage detector) 52, a current detection circuit (or current detector) 54, a rotation angle detection circuit (or rotation angle detector) 56, and a temperature detection circuit (or temperature detector) 58. The voltage detection circuit 52, the current detection circuit 54, the rotation angle detection circuit 56, and the temperature detection circuit 58 are electrically coupled to the control circuit 50. At least one of the voltage detection circuit 52, the current detection circuit 54, or the temperature detection circuit 58 may be omitted.

The voltage detection circuit 52 detects a magnitude of the battery voltage. The voltage detection circuit 52 outputs a voltage detection signal to the control circuit 50. The voltage detection signal has a variable voltage corresponding to the magnitude of the battery voltage.

The current detection circuit 54 is on the negative-side current path Ln. The current detection circuit 54 detects a magnitude of a drive current ibat flowing through the motor 30. The current detection circuit 54 outputs a drive current detection signal to the control circuit 50. The drive current detection signal has a variable voltage corresponding to the magnitude of the drive current ibat. The drive current ibat corresponds to any of a U-phase current iu, a V-phase current iv, and a W-phase current iw. The U-phase current iu corresponds to an electric current flowing between the drive circuit 42 and the first terminal 30u. The V-phase current iv corresponds to an electric current flowing between the drive circuit 42 and the second terminal 30v. The W-phase current iw corresponds to an electric current flowing between the drive circuit 42 and the third terminal 30w. For example, when the first switch Q1 and the fifth switch Q5 are ON, the U-phase current iu and the V-phase current iv correspond to the drive current ibat.

The rotation angle detection circuit 56 receives the first through third Hall signals from the rotation sensor 32. The rotation angle detection circuit 56 detects a rotation angle (or a rotational position) of the rotor 30r (hereinafter referred to as a rotor angle) based on the first through third Hall signals.

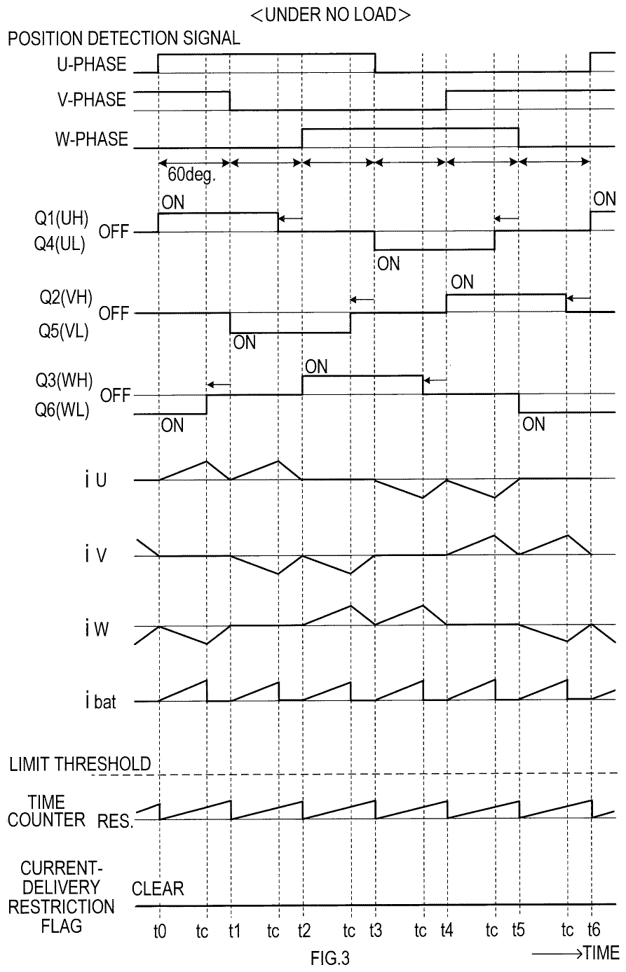

The rotation angle detection circuit 56 includes a not-shown waveform shaping circuit. This waveform shaping circuit shapes the first through third Hall signals into first through third position detection signals, respectively, each having a pulse shape (see FIG. 3 through FIG. 5). The logical value of each of the first through third position detection signals is also inverted each time the rotor 30r rotates by 180 electrical degrees, and the first through third position detection signals are also out of phase with each other by 120 electrical degrees. The first position detection signal corresponds to the U-phase, the second position detection signal corresponds to the V-phase, and the third position detection signal corresponds to the W-phase. The rotation angle detection circuit 56 outputs the first through third position detection signals. The first through third position detection signals are input to the control circuit 50.

The control circuit 50 detects the rotor angle based on the first through third position detection signals. The control circuit 50 can detect the rotor angle with a resolution of 60 electrical degrees. The control circuit 50 also detects, based on the first through third position detection signals, an actual number of rotations per unit time (i.e., an actual rotational frequency or an actual rotational speed) of the motor 30.

The rotation angle detection circuit 56 may output a rotation angle detection signal each time a rising edge or a falling edge occurs in any of the first through third position detection signals (i.e., at 60 electrical degree intervals). In this case, each time the control circuit 50 receives the rotation angle detection signal, the control circuit 50 may detect (or recognize) that the rotor 30r has rotated by 60 electrical degrees (and further may detect the rotor angle).

The temperature detection circuit 58 outputs a temperature detection signal to the control circuit 50. The temperature detection circuit 58 includes a temperature sensor (e.g., a thermistor) provided to the drive circuit 42. The temperature detection signal directly or indirectly indicates a temperature of the first through sixth switches Q1, Q2, Q3, Q4, Q5, and Q6 (i.e., a temperature of the drive circuit 42). The temperature detection signal has a variable voltage corresponding to the temperature of the first through sixth switches Q1, Q2, Q3, Q4, Q5, and Q6.

### [2-1-3. Operation by Control Circuit]

Next, control of the motor 30 by the control circuit 50 will be described with reference to FIG. 3 through FIG. 5.

As shown in FIG. 3, the control circuit 50 basically delivers a first electric power to the motor 30 by performing a conduction control to thereby drive the motor 30. The conduction control includes the control circuit 50 driving the first through sixth switches Q1, Q2, Q3, Q4, Q5, and Q6 in pairs each time the rotor 30r rotates (e.g., rotates in a forward direction) by 60 electrical degrees. In this first embodiment, each time the rotor 30r rotates by 60 electrical degrees, the control circuit 50 sequentially drives the following first through sixth pairs through the gate circuit 44.
The first pair: the first switch Q1 and the sixth switch Q6
The second pair: the first switch Q1 and the fifth switch Q5
The third pair: the third switch Q3 and the fifth switch Q5
The fourth pair: the third switch Q3 and the fourth switch Q4
The fifth pair: the second switch Q2 and the fourth switch Q4
The sixth pair: the second switch Q2 and the sixth switch Q6

Of the first through sixth pairs, any one pair to be driven (hereinafter referred to as a “driven pair”) is driven according to a first conduction pattern. The driving according to the first conduction pattern may be any of first through third driven modes.

The first driven mode corresponds to fixing (or maintaining) both of the two switches in the driven pair to be ON. In a conduction angle control to be described below, the driven pair is driven in the first driven mode.

The second driven mode corresponds to fixing one switch (hereinafter referred to as a “non-PWM-driven switch”) in the driven pair to be ON and repeatedly (i.e., periodically) turning on and off the other switch (hereinafter referred to as a “PWM-driven switch”) at regular intervals. The PWM-driven switch is driven with a PWM signal, and the non-PWM-driven switch is driven with a non-PWM signal. In the first driven mode, the two switches in the driven pair are both non-PWM-driven switches.

The third driven mode corresponds to turning on both of the two switches in the driven pair periodically, that is, driving both of the two switches with PWM signals. In the third driven mode, the two switches in the driven pair are both PWM-driven switches.

In a PWM control to be described below, the driven pair is driven in the second driven mode. In the PWM control, the driven pair may be driven in the third driven mode. Driving the first switch Q1 means fixing the first switch Q1 to be ON or turning the first switch Q1 on and off periodically. The same applies to the second through sixth switches Q2, Q3, Q4, Q5, and Q6.

The electrical angle of 60 degrees is one example of the reference rotation angle described in “Overview of Embodiments”. In the description below, the electrical angle of 60 degrees is referred to as the reference rotation angle depending on situations.

The control circuit 50 switches the driven pairs at each of update timings t0, t1, t2, . . . of the first through third position detection signals. Specifically, the driven pairs are switched in an order from the first pair to the sixth pair. After the sixth pair, the first pair is driven.

The update timing arrives each time the motor 30 rotates by the reference rotation angle. Specifically, the update timing corresponds to a timing at which a rising edge or a falling edge occurs in any of the first through third position detection signals. In a case where the rotation angle detection circuit 56 is configured to output the rotation angle detection signal, the update timing corresponds to a timing at which the rotation angle detection signal is output. In other words, the update timing arrives each time the motor 30 rotates by 60 electrical degrees. In the example shown in FIG. 3, the first pair is set as the driven pair at the update timing t0, and the second pair is set as the driven pair at the update timing t1.

When the motor 30 is rotated in a reverse direction, for example, the first through sixth pairs are sequentially driven in a different order from that at the time of rotation in the forward direction. In other words, the first through sixth pairs and/or the order of driving them are/is individually set in advance according to the rotation direction of the motor 30.

In response to the driven pairs being sequentially switched in the order from the first pair to the sixth pair, the drive current ibat is delivered to the motor 30. This causes the motor 30 to generate a rotational torque in the forward direction.

The rotational torque of the motor 30 varies according to the drive current ibat (i.e., according to the U-phase, V-phase, and W-phase currents iu, iv, and iw, in other words, according to the electric power delivered to the motor 30). Thus, the control circuit 50 performs the conduction angle control as the above-described conduction control. In the conduction angle control, the driven pair is basically driven in the first driven mode. However, in the conduction angle control of this first embodiment, a time period in which the driven pair is driven is controlled within a reference control period (or a conduction control period). The reference control period is a period in which the motor 30 rotates by the reference rotation angle (i.e., by 60 electrical degrees). A length of the conduction control period, that is, a time required for the motor 30 to rotate by the reference rotation angle (hereinafter referred to as a “reference rotation time”) varies according to the actual rotational frequency of the motor 30.

Specifically, in the conduction angle control, as shown in FIG. 3, in each reference control period, the drive current ibat is stopped at an OFF-timing tc within this reference control period. Specifically, after the driving of the driven pair corresponding to the start of the reference control period (i.e., the update timing) is started, either one of the switches in this driven pair is turned off at the OFF-timing tc. The OFF-timing tc arrives before the next update timing arrives (i.e., before the reference control period for this driven pair ends). The period from start of the reference control period till the OFF-timing tc corresponds to a conduction angle. In the conduction angle control, the conduction angle is calculated. Then, when the motor 30 rotates by a rotation angle corresponding to the calculated conduction angle after the reference control period started, the drive current ibat is stopped.

The control circuit 50 sets the OFF-timing tc (i.e., sets the conduction angle) according to the rotation state of the motor 30 in each reference control period, thereby controlling the motor 30 to be in a desired rotation state.

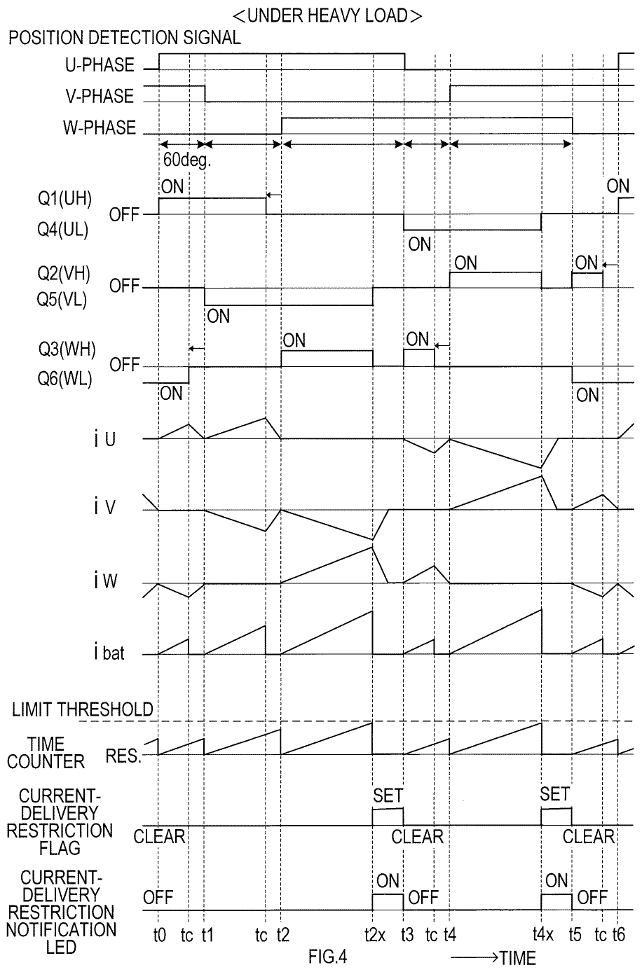

The conduction angle control can be performed properly when the motor 30 is operated under no load or operated normally. On the other hand, when the motor 30 is operated under heavy load, a rotational speed of the motor 30 decreases. FIG. 4 shows an example in which the motor 30 is operated under heavy load.

As shown in FIG. 4 (see, especially, the update timings t1, t2, and t3), when the rotational speed of the motor 30 decreases, the reference rotation time becomes longer, and an actual drive time (or a conduction time or an actual conduction time or a conduction control time) of the motor 30 within the reference control period also becomes longer. The actual drive time is a time period during which the drive current ibat is delivered to the motor 30, in other words, a time period during which the driven pair is driven.

When the actual drive time within the reference control period becomes longer, the drive current ibat rises (i.e., absolute values of the U-phase, V-phase, and W-phase currents iu, iv, and iw increase), thus raising a peak value of the drive current ibat. This may lead to occurrence of a failure in any of the first through sixth switches Q1, Q2, Q3, Q4, Q5, and Q6 and/or demagnetization of the permanent magnet in the motor 30.

Under such circumstances, in this first embodiment, the control circuit 50 measures, each time the update timing arrives, an elapsed time since this update timing (i.e., the actual drive time). Specifically, as shown in FIG. 3 and FIG. 4, the control circuit 50 starts, at each update timing, counting with a time counter. Specifically, the control circuit 50 periodically increments a count value of the time counter (hereinafter referred to as a “first count value”). The first count value corresponds to the actual drive time (i.e., is equivalent to the actual drive time).

The control circuit 50 determines whether the first count value has reached a limit threshold. In other words, the control circuit 50 determines whether the actual drive time has reached a limit time. The limit time corresponds to the limit threshold (i.e., is equivalent to the limit threshold). The first count value reaching the limit threshold has the same meaning as the actual drive time reaching the limit time. The limit threshold may be set in advance.

If the first count value has not reached the limit threshold yet, the control circuit 50 keeps a current-delivery restriction flag in a cleared state and continues the conduction angle control (see FIG. 3).

On the other hand, as shown in FIG. 4, when the motor 30 is for example operated under heavy load, the reference rotation time becomes longer, and the first count value may reach the limit threshold. In FIG. 4, after the update timing t2 arrives, the first count value has reached the limit threshold at a timing t2x, which is before the OFF-timing tc. In response to the first count value having reached the limit threshold, the control circuit 50 (i) sets the current-delivery restriction flag and (ii) thereby turns off all of the first through sixth switches Q1, Q2, Q3, Q4, Q5, and Q6. In other words, the control circuit 50 suspends the conduction angle control and performs the current-delivery restriction. The current-delivery restriction of this first embodiment includes turning off the driven pair to thereby stop power-delivery to the motor 30. This results in inhibiting rise in the drive current ibat and inhibiting a failure in the first through sixth switches Q1, Q2, Q3, Q4, Q5, and Q6 and deterioration of the motor 30. The first count value having reached the limit threshold is one example of the first abnormality described in Overview of Embodiments.

After the first count value reaches the limit threshold, when the next update timing t3 arrives, the control circuit 50 clears the current-delivery restriction flag (i.e., stops the current-delivery restriction) and resumes the conduction angle control.

Even when the current-delivery to the motor 30 is stopped in response to the first count value having reached the limit threshold, the motor 30 can continue to rotate by inertia. Thus, another update timing t3 arrives, and the conduction angle control is resumed. Accordingly, the driving of the motor 30 through the conduction angle control is continued.

When the current-delivery restriction flag is set and the current-delivery to the motor 30 is thereby stopped, the control circuit 50 turns on the current-delivery restriction notification LED 16. That is, the user is notified that the current-delivery to the motor 30 is being restricted due to a decrease in the actual rotational frequency of the motor 30. This allows the user to recognize that the electric work machine 1 is performing a heavy-load work. Based on such recognition, the user can then operate the electric work machine 1 so that the load is reduced.

On the other hand, for example, the rotary blade 5 may become unable to rotate due to the grass getting entangled with the rotary blade 5. When the rotary blade 5 becomes unable to rotate, the motor 30 is forcibly stopped. That is, the motor 30 is locked. In such a case, after the current-delivery restriction flag is set, the next update timing does not arrive, and the conduction angle control is not resumed. The lock of the motor 30 may be caused by an object different from the electric work machine 1, other than the grass.

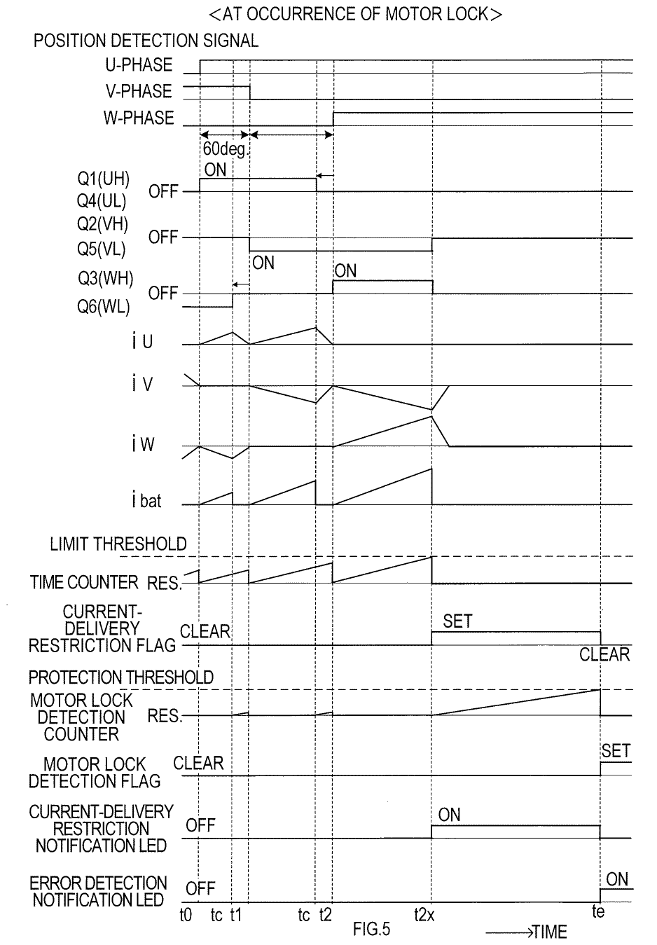

Under such circumstances, as shown in FIG. 5, the control circuit 50 measures an elapsed time since when the first count value reached the limit threshold (in more detail, since when the first through sixth switches Q1, Q2, Q3, Q4, Q5, and Q6 were all turned off) (hereinafter referred to as a “suspension duration time” (or a current-delivery suspension time)) with a motor lock detection counter. Specifically, the control circuit 50 periodically increments a count value of the motor lock detection counter (hereinafter referred to as a “second count value”). The second count value corresponds to the suspension duration time (i.e., is equivalent to the suspension duration time).

The control circuit 50 determines whether the second count value has reached a protection threshold (or a protection detection threshold). The second count value having reached the protection threshold corresponds to a protection determination time having elapsed without arrival of the update timing since the start of the current-delivery restriction. That is, the protection threshold is equivalent to the protection determination time. The protection threshold may be set in advance. In FIG. 5, the second count value reaches the protection threshold at a timing the. When the second count value reaches the protection threshold, the control circuit 50 determines that the motor 30 has been locked. Specifically, the control circuit 50 (i) sets a motor lock detection flag, (ii) turns on the error detection notification LED 15, (iii) clears the current-delivery restriction flag and the motor lock detection counter, and (iv) turns off the current-delivery restriction notification LED 16.

The user can recognize that the motor 30 has been locked based on the error detection notification LED 15 having been turned on. This allows the user to do the work for releasing the lock of the motor 30. Specifically, the user can remove the grass entangled with the rotary blade 5, for example.

As described above, when the second count value reaches the protection threshold, the current-delivery restriction flag and the motor lock detection counter are cleared. Thus, after the lock of the motor 30 is released, the conduction angle control can be resumed.

### [2-1-4. Flow Chart]

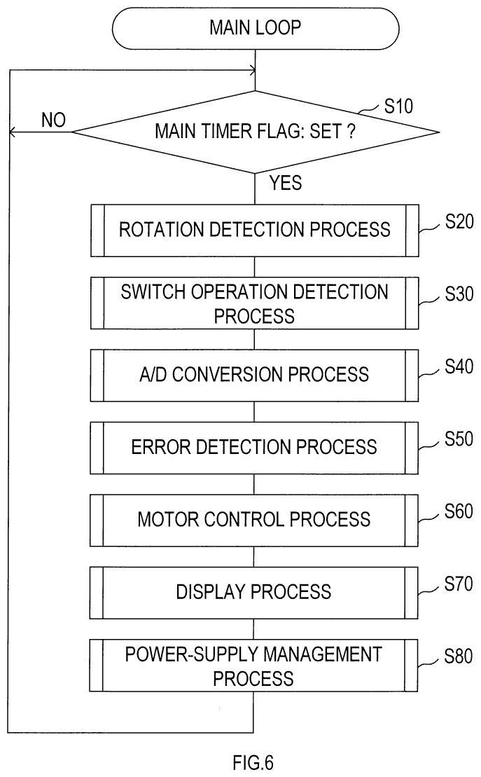

A description will be given of a main control process executed by the control circuit 50 to control the motor 30, with reference to FIG. 6.

In this first embodiment, when the control circuit 50 determines that the battery pack 18 is in a normal state and that the battery pack 18 has an electric energy greater than or equal to a minimum electric energy, the control circuit 50 executes the main control process shown in FIG. 6 as a main loop. An amount of this minimum electric energy may be any amount and, for example, may be a minimum amount required to start the motor 30.

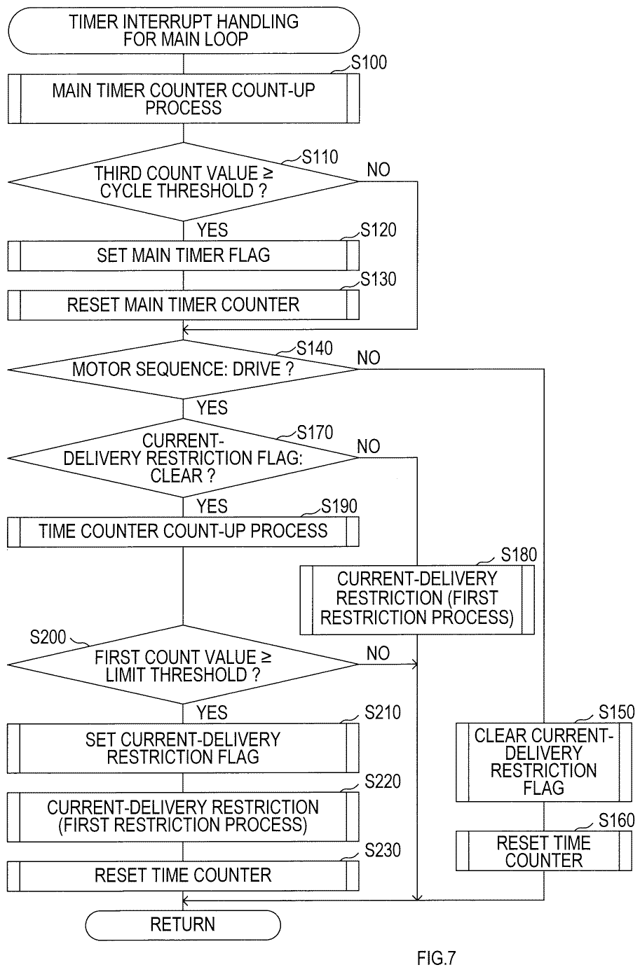

As shown in FIG. 6, in S10 (S represents step), the control circuit 50 determines whether a main timer flag is set. The main timer flag is set in a timer interrupt handling for the main loop shown in FIG. 7. The main timer flag is set when a main timer counter is determined to have reached a threshold. In other words, the main timer flag is set in each specified control cycle.

In the case where the main timer flag is not set in S10, a specific time period corresponding to the control cycle has not elapsed yet since the process of S20 was started last time. Thus, in this case, the control circuit 50 executes the determination process of S10 again. In other words, the control circuit 50 waits for the specific time period to elapse.

In the case where the main timer flag is set in S10, the specific time period has elapsed since the process of S20 was started last time. Thus, in this case, the control circuit 50 clears the main timer flag, executes the processes of S20 through S80, and proceeds to S10.

In S20, the control circuit 50 executes a rotation detection process (or a Hall signal detection process). Specifically, the control circuit 50 determines whether a rising edge or a falling edge has occurred in any of the first through third position detection signals since S20 of last time till S20 of this time. If the rising edge or the falling edge has occurred, a position update flag is set. In other words, the position update flag is set each time the motor 30 rotates by the reference rotation angle.

In S30, the control circuit 50 executes a switch operation detection process. Specifically, the control circuit 50 detects operation states of various manual switches (e.g., the trigger switch 10) provided to the operation/display unit 8.

In S40, the control circuit 50 executes an A/D conversion process. Specifically, the control circuit 50 A/D-converts various analog signals input to the control circuit 50. Such various analog signals include the voltage detection signal from the voltage detection circuit 52, the drive current detection signal from the current detection circuit 54, and the temperature detection signal from the temperature detection circuit 58. Through this process, the control circuit 50 obtains the magnitude of the battery voltage, the magnitude of the drive current ibat, the temperature of the drive circuit 42, and so on.

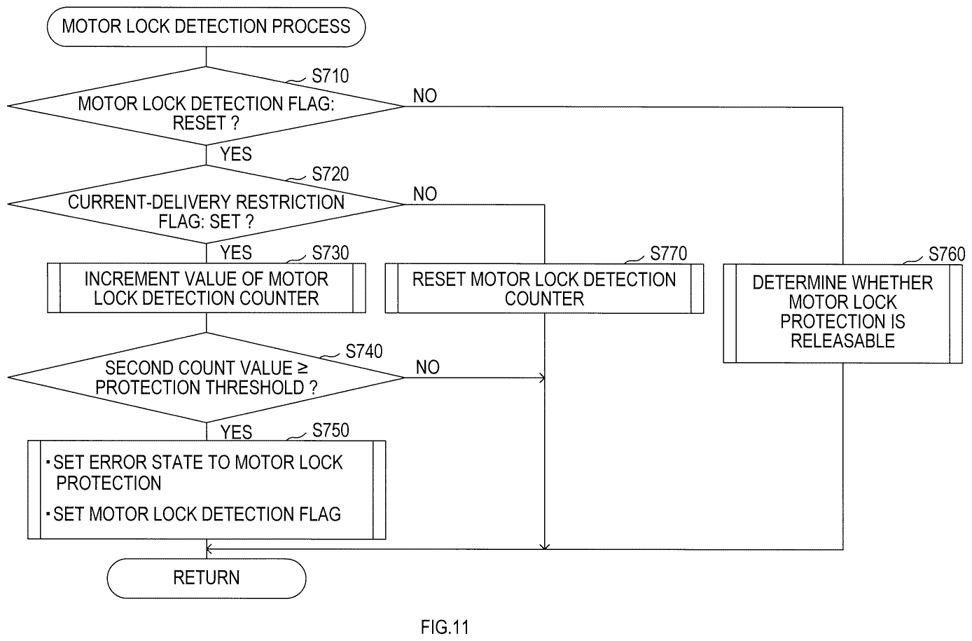

In S50, the control circuit 50 executes an error detection process. Specifically, the control circuit 50 determines whether the operation state of the electric work machine 1 is normal. If the operation state is abnormal, the control circuit 50 activates a protection function. The protection function may be determined in advance. The error detection process includes a motor lock detection process (see FIG. 11), which will be described below.

In S60, the control circuit 50 executes a motor control process. Specifically, the control circuit 50 calculates the conduction angle in each reference control period in order to drive and control the motor 30 through the conduction angle control. The control circuit 50 outputs the first through sixth control signals UH, VH, WH, UL, VL, and WL to the gate circuit 44 based on the calculated conduction angle. The control circuit 50 thus controls the current-delivery to the motor 30.

In S70, the control circuit 50 executes a display process. Specifically, the control circuit 50 turns on or off the two or more LEDs provided to the display panel 14, thereby displaying the state of the electric work machine 1.

In S80, the control circuit 50 executes a power-supply management process. Specifically, in a case where, for example, (i) the trigger switch 10 has not been operated for a specified time period or longer and (ii) a condition for shifting into a power-saving mode is met, the control circuit 50 sets the control circuit 50 into a sleep state. After the process of S80, the process proceeds to S10. In this way, the process of S10 and thereafter is executed repeatedly.

Next, the timer interrupt handling for the main loop will be described with reference to FIG. 7. The timer interrupt handling for the main loop is repeatedly executed at specified execution intervals. Each specified execution interval is sufficiently short compared with the control cycle of the main loop.

Upon starting the timer interrupt handling for the main loop, the control circuit 50 executes a main timer counter count-up process in S100. Specifically, the control circuit 50 increments a count value of the main timer counter (hereinafter referred to as a “third count value”) by “1”.

In S110, the control circuit 50 determines whether the current third count value is greater than or equal to a cycle threshold. The cycle threshold corresponds to the control cycle of the main loop.

If the third count value is greater than or equal to the cycle threshold in S110, the process proceeds to S120. In S120, the control circuit 50 sets the main timer flag. In S130, the control circuit 50 resets the main timer counter. If the third count value is not greater than or equal to the cycle threshold in S110, the process proceeds to S140.

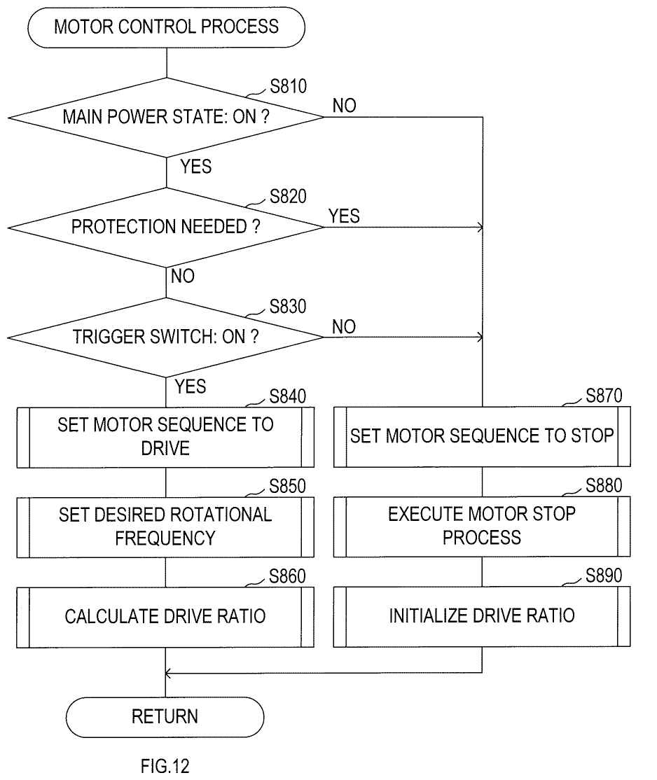

In S140, the control circuit 50 determines whether a motor sequence is set to “DRIVE”. The motor sequence is set to “DRIVE” or “STOP” in the motor control process (see FIG. 12), which will be described below. If the motor sequence is not set to “DRIVE” in S140, the motor 30 need not be driven. Thus, in this case, the process proceeds to S150. In S150, the control circuit 50 clears the current-delivery restriction flag. In S160, the control circuit 50 resets the time counter and terminates the timer interrupt handling for the main loop. Resetting the time counter includes setting the first count value to an initial value (0, for example).

In S140, if the motor sequence is set to “DRIVE”, the motor 30 needs to be driven. Thus, in this case, the process proceeds to S170. In S170, the control circuit 50 determines whether the current-delivery restriction flag has been cleared.

If the current-delivery restriction flag is not cleared (i.e., is set) in S170, the process proceeds to S180. In S180, the control circuit 50 performs the current-delivery restriction to thereby reduce or stop the drive current ibat. The current-delivery restriction of the present first embodiment includes a first restriction process (or an output suspension process). The first restriction process includes stopping delivery of the drive current ibat to the motor 30. Specifically, the control circuit 50 turns off all of the first through sixth switches Q1, Q2, Q3, Q4, Q5, and Q6 through the gate circuit 44. After the process of S180, the control circuit 50 terminates the timer interrupt handling for the main loop.

In S170, if the current-delivery restriction flag has been cleared, the process proceeds to S190. In S190, the control circuit 50 executes the time counter count-up process. Specifically, the control circuit 50 increments the first count value of the time counter by “1”.

In S200, the control circuit 50 determines whether the first count value is greater than or equal to the limit threshold. If the first count value is smaller than the limit threshold, the control circuit 50 terminates the timer interrupt handling for the main loop.

If the first count value is greater than or equal to the limit threshold in S200, the process proceeds to S210. In S210, the control circuit 50 sets the current-delivery restriction flag.

In S220, the control circuit 50 performs the current-delivery restriction (i.e., the first restriction process) as performed in S180.

In S230, the control circuit 50 resets the time counter and terminates the timer interrupt handling for the main loop.

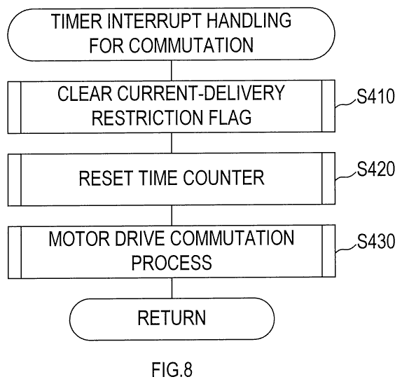

Next, a timer interrupt handling for commutation will be described with reference to FIG. 8. The timer interrupt handling for commutation is executed at each timing at which the rising edge or the falling edge occurs in any of the first through third position detection signals, that is, each time the motor 30 rotates by the reference rotation angle.

Upon starting the timer interrupt handling for commutation, the control circuit 50 clears the current-delivery restriction flag in S410. In S420, the control circuit 50 resets the time counter. In S430, the control circuit 50 executes a motor drive commutation process. Specifically, the control circuit 50 switches the driven pairs according to a switching pattern (i.e., the order of the first pair through the sixth pair) set in advance.

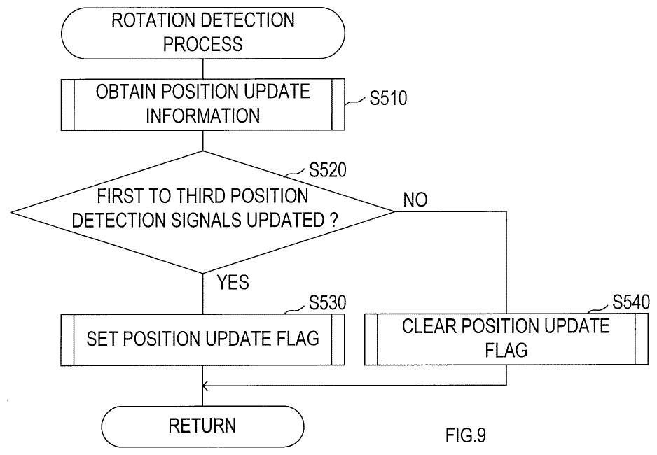

The rotation detection process of S20 in FIG. 6 will be specifically described with reference to FIG. 9. Upon proceeding to the rotation detection process, the control circuit 50 obtains position update information in S510. The position update information indicates whether any of the first through third position detection signals has been updated, that is, whether the rising edge or the falling edge has occurred in any of the first through third position detection signals. The control circuit 50 may obtain the position update information based on, for example, an execution state of the timer interrupt handling for commutation.

In S520, the control circuit 50 determines whether any of the first through third position detection signals has been updated based on the position update information.

If it is determined in S520 that any of the first through third position detection signals has been updated, the process proceeds to S530. In S530, the control circuit 50 sets the position update flag (or an update flag for the Hall signal) and terminates the rotation detection process.

If it is determined in S520 that none of the first through third position detection signals have been updated, the process proceeds to S540. In S540, the control circuit 50 clears the position update flag and terminates the rotation detection process.

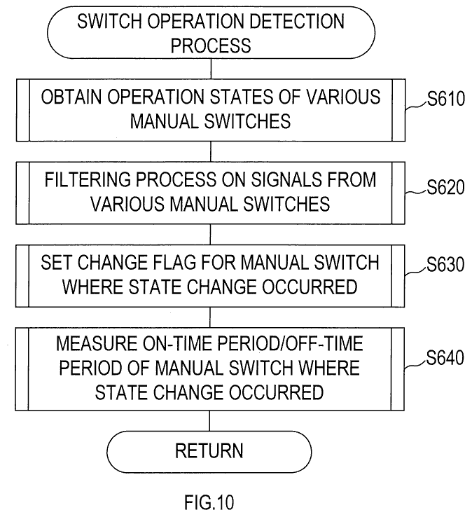

Next, the switch operation detection process of S30 will be described with reference to FIG. 10. Upon proceeding to the switch operation detection process, the control circuit 50 obtains the operation states of the various manual switches in S610. Specifically, the control circuit 50 obtains a signal output from the trigger switch 10 and a signal output from the main power switch 20.

In S620, the control circuit 50 performs a filtering process on each of the signals from the various manual switches, thus removing noise from the signals from the various manual switches. In the case where the control circuit 50 receives the trigger signal from the trigger switch 10, such a trigger signal is also subjected to the filtering process.

In S630, the control circuit 50 detects a change in the state of each of the various manual switches based on each signal subjected to the filtering process. Such change in the state includes being switched from OFF to ON and being switched from ON to OFF. If the change in the state occurs in any of the various manual switches, the control circuit 50 sets a change flag corresponding to the relevant manual switch.

In S640, the control circuit 50 measures an ON-time period or an OFF-time period of the manual switch for which the change flag is set.

The ON-time period and the OFF-time period are each calculated based on, for example, a time difference between the time at which the change flag was set last time and the time at which the change flag is set this time. In a case where the change flag is set based on the switching of the manual switch from ON to OFF, the ON-time period is calculated. In a case where the change flag is set based on the switching of the manual switch from OFF to ON, the OFF-time period is calculated.

Moreover, in S640, the control circuit 50 clears the change flag. In this way, in the switch operation detection process, the control circuit 50 detects, in addition to the operation states of the various manual switches, an operation period (i.e., the ON-time period or the OFF-time period) as well.

Next, the motor lock detection process included in the error detection process of S50 will be described with reference to FIG. 11.

Upon starting the motor lock detection process, the control circuit 50 determines, in S710, whether the motor lock detection flag has been reset. The motor lock detection flag having been reset corresponds to a motor lock protection not having been set.

If the motor lock detection flag has been reset in S710, the process proceeds to S720. In S720, the control circuit 50 determines whether the current-delivery restriction flag is set. In the case where the current-delivery restriction flag is set, the current-delivery to the motor 30 is being restricted (specifically, interrupted) through the first restriction process of S220. Thus, in this case, the process proceeds to S730. In S730, the control circuit 50 increments the second count value of the motor lock detection counter by “1”. In other words, the control circuit 50 measures the above-described suspension duration time.

In S740, the control circuit 50 determines whether the current second count value is greater than or equal to the protection threshold. If the second count value is greater than or equal to the protection threshold, the control circuit 50 determines that the motor 30 is locked and proceeds to S750. In S750, the control circuit 50 (i) sets an error state to the motor lock protection and (ii) sets the motor lock detection flag. After executing the process of S750, the control circuit 50 terminates the motor lock detection process.

In S740, if the second count value has not reached the protection threshold, the control circuit 50 terminates the motor lock detection process.

In S720, if the current-delivery restriction flag is not set, the motor 30 is being driven normally through the conduction angle control. Thus, in this case, the process proceeds to S770. In S770, the control circuit 50 resets the motor lock detection counter and terminates the motor lock detection process. Resetting the motor lock detection counter includes setting the second count value to an initial value (0, for example).

In S710, if the motor lock detection flag is set, that is, if the error state is set to the motor lock protection, the process proceeds to S760. In S760, the control circuit 50 determines whether the motor lock protection can be released. For example, the motor lock protection becomes releasable by the user performing an operation to release the lock of the motor 30.

In S760, upon determining that the motor lock protection can be released, the control circuit 50 (i) releases the setting of the motor lock protection and (ii) clears the motor lock detection flag.

Next, the motor control process of S60 will be described with reference to FIG. 12.

Upon starting the motor control process, the control circuit 50 determines, in S810, whether the controller 40 is in an ON-state (i.e., whether the main power state is an ON-state). If the controller 40 is in an ON-state, the process proceeds to S820.

In S820, the control circuit 50 determines whether the electric work machine 1 (specifically, the motor 30 and/or the controller 40, for example) needs to be protected from the error state. The control circuit 50 makes the determination of S820 based on the results of various error detection processes. The various error detection processes include the above-described motor lock detection process (see FIG. 11). The error state being set to the above-described motor lock protection corresponds to one of the situations in which the electric work machine 1 needs to be protected from the error state. If the electric work machine 1 need not be protected from the error state, the process proceeds to S830.

In S830, the control circuit 50 determines whether the trigger switch 10 is in an ON-state (i.e., is operated). The control circuit 50 can determine that the trigger switch 10 is in the ON-state based on the trigger signal subjected to the filtering process being received. If the trigger switch 10 is in an ON-state, the process proceeds to S840. In S840, the control circuit 50 sets the motor sequence to “DRIVE”. That is, the control circuit 50 permits driving of the motor 30.

If the controller 40 is determined in S810 to be in an OFF-state, or if the electric work machine 1 is determined in S820 to need to be protected from the error state, or if the trigger switch 10 is determined in S830 to be in an OFF-state (i.e., not to be operated), the process proceeds to S870. In S870, the control circuit 50 sets the motor sequence to “STOP”. That is, the control circuit 50 prohibits driving of the motor 30.

In S850, the control circuit 50 sets a desired rotational frequency (i.e., desired rotational speed) of the motor 30. Specifically, the control circuit 50 sets the desired rotational frequency based on the operation state of the trigger switch 10 and/or the current rotation state of the motor 30.

In S860, the control circuit 50 calculates a drive ratio (or a motor output duty ratio). The drive ratio is a time ratio of a period during which the driven pair is driven to the reference control period (i.e., is a duty ratio in a broad sense). The drive ratio is calculated such that the actual rotational frequency of the motor 30 is consistent with the desired rotational frequency set in S850.

The control circuit 50 sets a conduction angle time corresponding to the conduction angle based on the drive ratio. The control circuit 50 sets the set conduction angle time in a conduction angle clocking timer and causes the conduction angle clocking timer to operate.

Upon clocking the conduction angle time through the conduction angle clocking timer, the control circuit 50 turns off one or both (one, in this first embodiment) of the two switches in the driven pair. That is, the above-described conduction angle control is achieved.

In S880, the control circuit 50 executes a motor stop process. The motor stop process is a process for stopping the driving of the motor 30.

In the motor stop process, the motor 30 may be stopped through any method. For example, the drive current ibat to the motor 30 may be interrupted to thereby stop the motor 30. Alternatively, for example, two or more of the first through third terminals 30u, 30v, and 30w may be short-circuited to each other through the drive circuit 42 to thereby brake the motor 30. That is, the motor 30 may be braked or stopped by so-called dynamic braking.

In S890, the control circuit 50 initializes the drive ratio. Specifically, the control circuit 50 sets the drive ratio to an initial value (0%, for example).

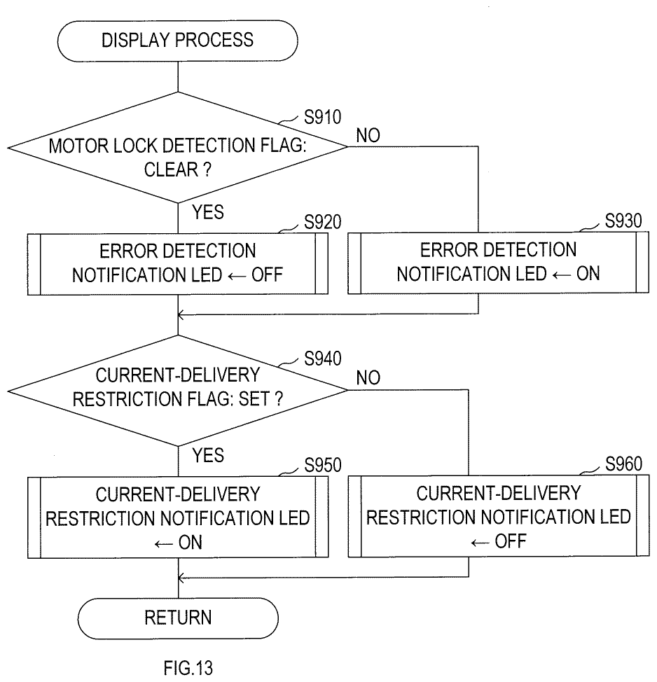

Next, the display process of S70 will be described with reference to FIG. 13.

Upon starting the display process, the control circuit 50 determines, in S910, whether the motor lock detection flag has been cleared. If the motor lock detection flag has been cleared, the process proceeds to S920. In S920, the control circuit 50 sets the error detection notification LED 15 to an OFF-state (i.e., turns off the error detection notification LED 15) and proceeds to S940. In S910, if the motor lock detection flag is not cleared (i.e., is set), the process proceeds to S930. In S930, the control circuit 50 sets the error detection notification LED 15 to an ON-state (i.e., turns on the error detection notification LED 15) and proceeds to S940.

In S940, the control circuit 50 determines whether the current-delivery restriction flag is set. If the current-delivery restriction flag is set, the process proceeds to S950. In S950, the control circuit 50 sets the current-delivery restriction notification LED 16 to an ON-state (i.e., turns on the current-delivery restriction notification LED 16) and terminates the display process. If the current-delivery restriction flag is not set (i.e., has been cleared), the process proceeds to S960. In S960, the control circuit 50 sets the current-delivery restriction notification LED 16 to an OFF-state (i.e., turns off the current-delivery restriction notification LED 16) and terminates the display process.

### 2-1-5. Effects

As described so far, in the electric work machine 1 of this first embodiment, the motor 30 is driven through the conduction angle control. During the driving of the motor 30, the actual drive time is measured (i.e., the first count value is counted up) at each update timing. When the actual drive time reaches the limit time (i.e., when the first count value reaches the limit threshold), the current-delivery to the motor 30 is interrupted through the first restriction process (S220).

Thus, when the actual rotational frequency of the motor 30 decreases due to a heavy-load work or the like, it is possible to inhibit the increase in the peak value of the drive current ibat and in the peak value of each of the U-phase, V-phase, and W-phase currents iu, iv, and iw. This makes it possible to inhibit a failure in the first through sixth switches Q1, Q2, Q3, Q4, Q5, and Q6 and/or demagnetization of the permanent magnet in the motor 30.

After executing the first restriction process of S220, upon arrival of the update timing (i.e., upon occurrence of the above-described rising edge or falling edge), the control circuit 50 resumes the current-delivery to the motor 30 through the conduction angle control. This enables continued driving of the motor 30 through the conduction angle control.

After starting the first restriction process of S220, during a period before resuming the current-delivery to the motor 30, the control circuit 50 turns on the current-delivery restriction notification LED 16, thereby notifying the user of the occurrence of the first abnormality (or a first current-delivery error) in the electric work machine 1.

In a case where the second abnormality (or a second current-delivery error) that requires the driving of the motor 30 to be stopped has occurred, the control circuit 50 turns on the error detection notification LED 15, thereby notifying the user of the occurrence of the second abnormality. The second abnormality includes the lock of the motor 30, that is, the motor lock detection flag having been set.

The turning-on of the current-delivery restriction notification LED 16 allows the user to recognize that the protection function of the electric work machine 1 is being operated. More specifically, the user can recognize the increase in the load in the motor 30 and/or the increase in the drive current ibat and in the U-phase, V-phase, and W-phase currents iu, iv, and iw due to such increase in the load. Moreover, in the case where the error that requires the driving of the motor 30 to be stopped occurs due to the occurrence of the motor lock or the like, the turning-on of the error detection notification LED 15 allows the user to recognize the lock of the motor 30 and, furthermore, the occurrence of the error that requires the driving of the motor 30 to be stopped.

The turning-on of the current-delivery restriction notification LED 16 and/or the error detection notification LED 15 allows the user to perceive the occurrence of the abnormality in the motor 30 and the nature of the abnormality. This can be expected to cause the user to operate the electric work machine 1 so that the abnormality is inhibited or removed.

In this first embodiment, the current-delivery restriction notification LED 16 and the error detection notification LED 15 notify the user of the first abnormality and the second abnormality, respectively. However, a single LED may notify the user of the first and second abnormalities. Even when the first abnormality occurs, a regular control is resumed at the next update timing. Thus, the user does not need to be notified of the occurrence of the first abnormality.

### 2-2. Second Embodiment

In the first embodiment, after the actual drive time reaches the limit time and the current-delivery to the motor 30 is interrupted, the first through sixth switches Q1, Q2, Q3, Q4, Q5, and Q6 are all kept in the OFF-state until the update timing arrives (i.e., until the current-delivery to the motor 30 is resumed). In other words, the first restriction process is executed as the current-delivery restriction.

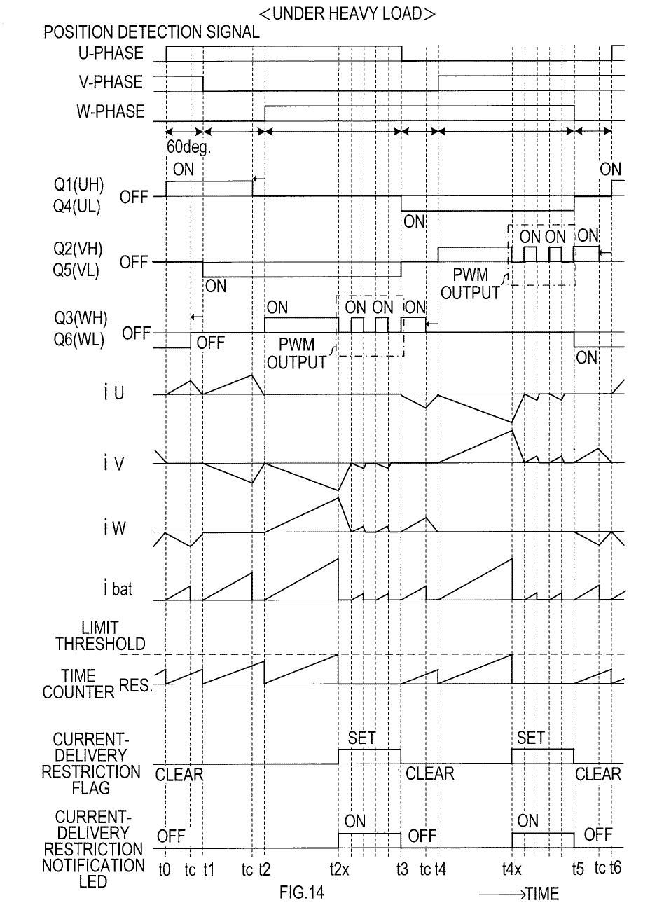

On the other hand, in this second embodiment, a second restriction process (or a PWM output process) is executed as the current-delivery restriction. Specifically, as shown in FIG. 14, the driven pair is driven according to a second conduction pattern during a period from when the actual drive time reaches the limit time till when the update timing arrives. More specifically, the driven pair is driven in the second driven mode. That is, one of the two switches in the driven pair is kept in the ON-state, and the other one is turned on and off periodically. In other words, one of the two switches is set as the non-PWM-driven switch, and the other one is set as the PWM-driven switch. This results in reducing the drive current ibat as compared with that in the regular conduction angle control. In other words, a second electric power is delivered to the motor 30. The second electric power is smaller than the first electric power (i.e., electric power to be delivered to the motor 30 through the conduction angle control).

When the driven pair is driven according to the second conduction pattern, the PWM-driven switch is driven by a first PWM signal as shown with dash-dotted lines in FIG. 14. The first PWM signal has a first duty ratio set in advance. The first duty ratio is set such that an amount of heat generation in a drive system for the motor 30 is smaller than an amount of heat generation at the time of executing the regular conduction angle control. The drive system for the motor 30 includes the drive circuit 42.

In this second embodiment, the driving of the driven pair is continued even after the actual drive time reaches the limit time. However, after the actual drive time reaches the limit time, the driven pair is driven in the second conduction pattern different from that in the regular conduction angle control (i.e., the first conduction pattern). The second conduction pattern is set such that the drive current ibat is reduced as compared with that in the regular conduction angle control. Thus, similarly to the first embodiment, a failure in the first through sixth switches Q1, Q2, Q3, Q4, Q5, and Q6 and demagnetization of the permanent magnet in the motor 30 can be inhibited.

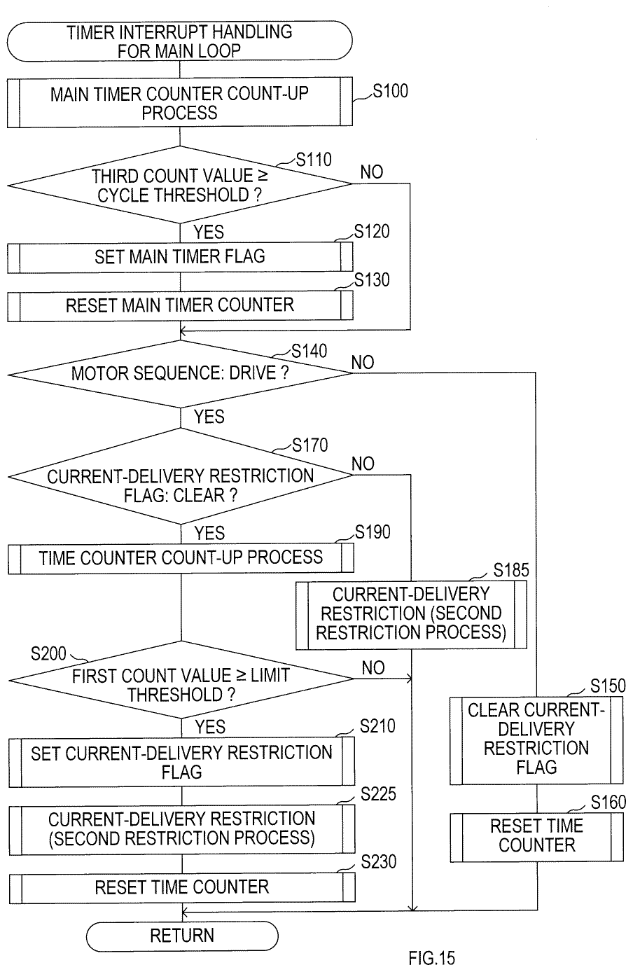

To achieve such a control of the motor 30, in this second embodiment, the control circuit 50 executes the timer interrupt handling for the main loop shown in FIG. 15 in place of the timer interrupt handling for the main loop in FIG. 7.

In the timer interrupt handling for the main loop shown in FIG. 15, processes of S225 and S185 are executed in place of the processes of S220 and S180 in FIG. 7, respectively. In S225 and S185, the control circuit 50 performs the current-delivery restriction (i.e., the second restriction process). The second restriction process includes outputting the first PWM signal as a control signal corresponding to the PWM-driven switch. The first duty ratio may be fixed or may be set to be variable according to a drive condition (e.g., battery voltage) of the motor 30.

In this second embodiment, even after the actual drive time reaches the limit time, the driven pair is driven according to the second conduction pattern to thereby continue the current-delivery to the motor 30.

### 2-3. Third Embodiment

In the first embodiment, after the actual drive time reaches the limit time, the current-delivery to the motor 30 is interrupted until the next update timing arrives.

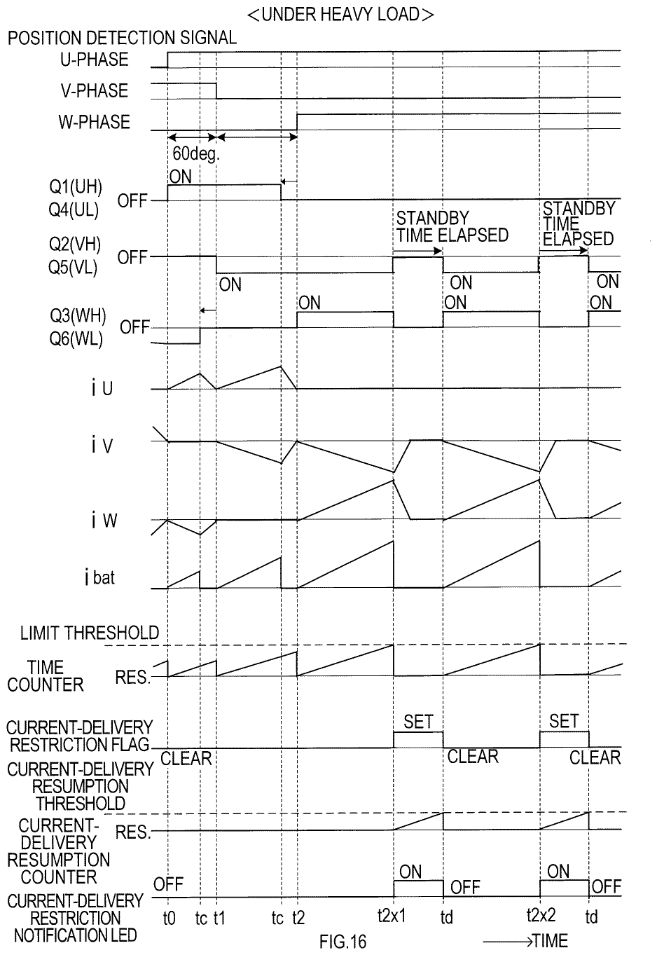

On the other hand, in this third embodiment, as shown in FIG. 16, after the actual drive time reaches the limit time, the current-delivery to the motor 30 is interrupted during a period until elapse of a specific standby time. Then, after the elapse of the standby time, the current-delivery to the motor 30 is resumed.

Such a control method also makes it possible to inhibit a failure in the first through sixth switches Q1, Q2, Q3, Q4, Q5, and Q6 and demagnetization of the permanent magnet in the motor 30 similarly to the first embodiment.

It is during the standby time that the interruption of the current-delivery is continued, and the current-delivery is resumed after the elapse of the standby time. Thus, even when a state continues in which the update timing does not arrive due to, for example, a sudden deceleration of the motor 30, the motor 30 can be driven by intermittent delivery of the drive current ibat to the motor 30, while restricting the peak values of the drive current ibat and of the U-phase, V-phase, and W-phase currents iu, iv, and iw.

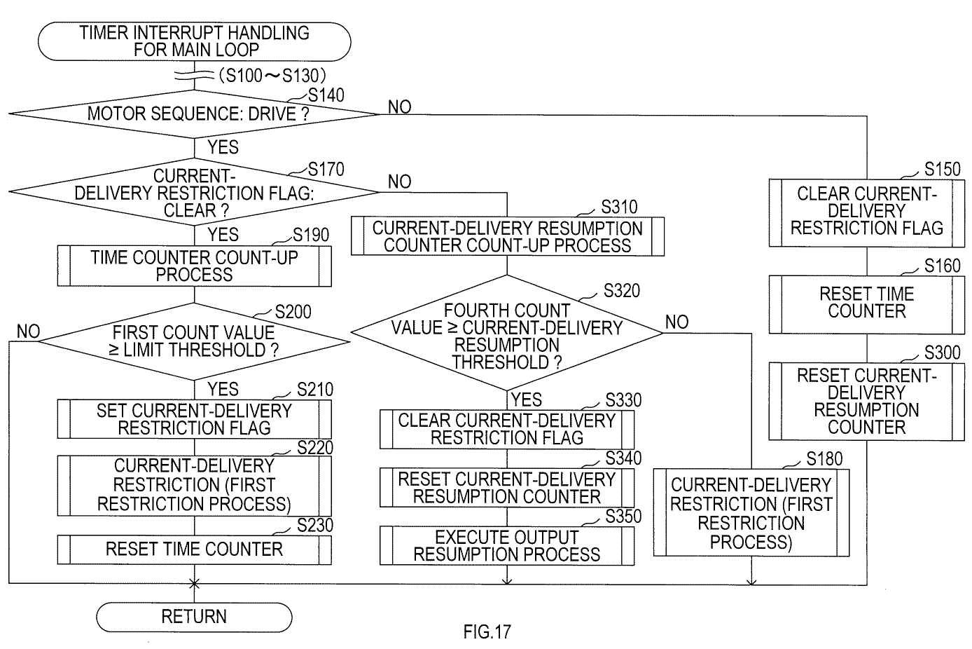

To achieve such a control of the motor 30, in this third embodiment, the control circuit 50 executes the timer interrupt handling for the main loop shown in FIG. 17 in place of the timer interrupt handling for the main loop in FIG. 7.

In FIG. 17, although not shown fully, the processes of S100 through S130 are executed similarly to the processes of S100 through S130 in the timer interrupt handling for the main loop in FIG. 7. In FIG. 17, the processes of S300 through S350 are added to the timer interrupt handling for the main loop in FIG. 7.

The process of S300 is executed after the process of S160. In S300, the control circuit 50 resets a count value (hereinafter referred to as a “fourth count value”) of a current-delivery resumption counter and terminates the timer interrupt handling for the main loop.

The current-delivery resumption counter is a counter for clocking an elapsed time since when the actual drive time reached the limit time (i.e., since when the current-delivery to the motor 30 was stopped).

The process of S310 is executed when it is determined in S170 that the current-delivery restriction flag is not cleared. In S310, the control circuit 50 executes the current-delivery resumption counter count-up process. Specifically, the control circuit 50 increments the fourth count value by “1”. During a period in which the current-delivery restriction flag is set (i.e., in which the current-delivery to the motor 30 is suspended), the process of S310 is executed repeatedly, thereby measuring a time in which the current-delivery to the motor 30 is suspended.

After the process of S310, the process proceeds to S320. In S320, the control circuit 50 determines whether the fourth count value is greater than or equal to a current-delivery resumption threshold. The current-delivery resumption threshold corresponds to the standby time. In S320, if the fourth count value is not greater than or equal to the current-delivery resumption threshold, the process proceeds to S180. The process of S180 and thereafter is the same as that shown in FIG. 7.

In S320, if the fourth count value is greater than or equal to the current-delivery resumption threshold, the process proceeds to S330. In S330, the control circuit 50 clears the current-delivery restriction flag. In S340, the control circuit 50 resets the current-delivery resumption counter and proceeds to S350.

In S350, the control circuit 50 executes an output resumption process. Specifically, the control circuit 50 turns on the driven pair turned off in S220 again, thereby resuming the conduction angle control. After executing the process of S350, the control circuit 50 terminates the timer interrupt handling for the main loop.

If it is determined in S170 that the current-delivery restriction flag has been cleared, the processes of S190 through S230 are executed similarly to those in FIG. 7.

In this third embodiment too, the motor lock detection process shown in FIG. 11 is executed similarly to the first embodiment. However, in this third embodiment, what is determined in S720 is not whether the current-delivery restriction flag is set but whether the position update flag has been cleared. This is because, in this third embodiment, the current-delivery restriction flag has been cleared by the process of S330 when the output resumption process of S350 is to be started.

The position update flag is set in response to any of the first through third position detection signals having been updated in the rotation detection process (FIG. 9) and is cleared if none of the first through third position detection signals has been updated.

Thus, in this third embodiment, if the position update flag has been cleared in S720, the control circuit 50 proceeds to S730 and increments the second count value by “1”. This makes it possible to measure the suspension duration time of the motor 30, thus detecting the lock of the motor 30 based on the measured suspension duration time.

### 2-4. Fourth Embodiment

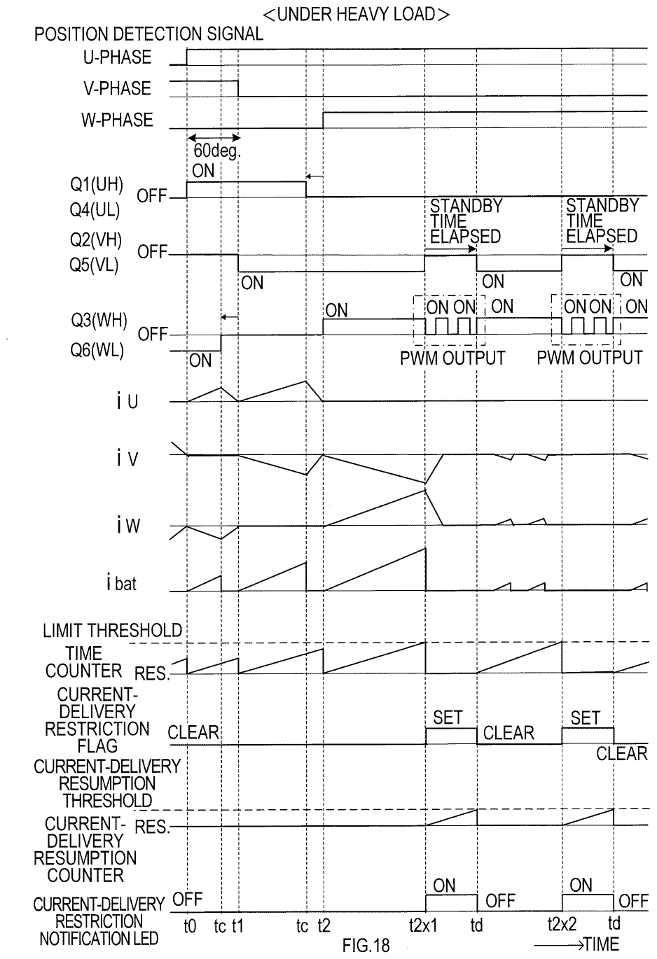

In this fourth embodiment, as shown in FIG. 18, a PWM output period of the second embodiment shown in FIG. 14 is limited to a specific standby time as in the third embodiment and, after the elapse of the standby time, the regular conduction angle control is resumed.

Even in such a case, similarly to the second embodiment, after the actual drive time reaches the limit time and the current-delivery to the motor 30 is interrupted, the first PWM signal is output to allow an electric current to flow through the motor 30 during the period until the conduction control is resumed. Moreover, after the regular conduction angle control is stopped, when the time during which the first PWM signal is output reaches the standby time defined by the current-delivery resumption threshold, the conduction angle control can be resumed. Thus, the driving of the motor 30 can be achieved as in the third embodiment.

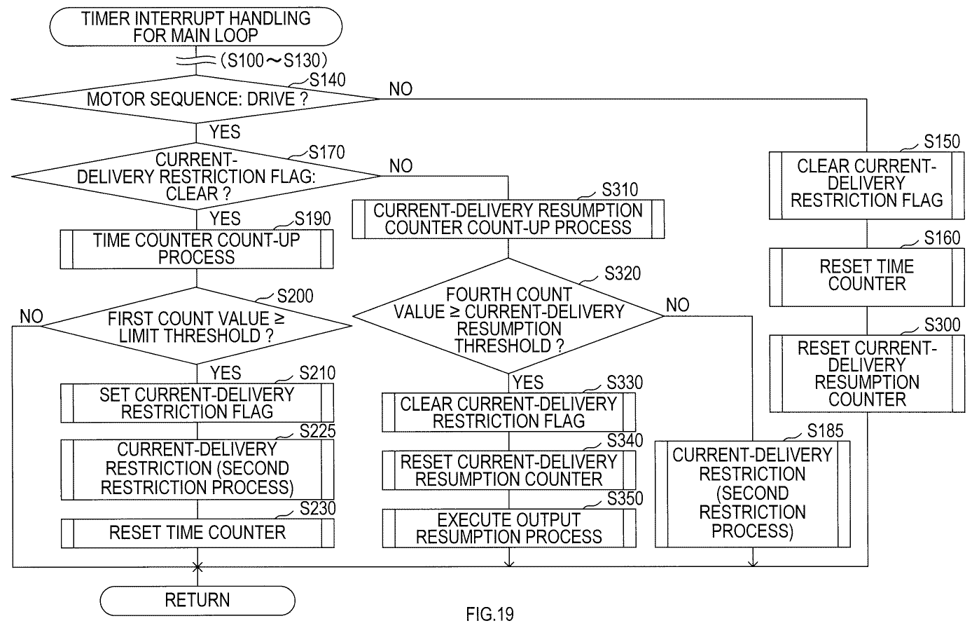

In this way, an output period of the first PWM signal, from when the actual drive time reaches the limit time till when the conduction angle control is resumed, is limited to the specific standby time. To achieve such a control, the control circuit 50 of this fourth embodiment executes the timer interrupt handling for the main loop through the processes shown in FIG. 19.

The timer interrupt handling for the main loop shown in FIG. 19 is substantially the same as the timer interrupt handling for the main loop of the third embodiment shown in FIG. 17. The timer interrupt handling for the main loop shown in FIG. 19 is different from that of the third embodiment in that the processes of S225 and S185 are executed in place of the processes of S220 and S180, respectively, shown in FIG. 17. The processes of S225 and S185 are the same as those of the second embodiment. That is, in S225 and S185, the control circuit 50 performs the current-delivery restriction (specifically, the second restriction process) as in the second embodiment. In other words, the control circuit 50 outputs the first PWM signal as a control signal corresponding to the PWM-driven switch.

Moreover, in this fourth embodiment too, in S720 of the motor lock detection process shown in FIG. 11, a similar process as in the third embodiment is executed. Specifically, what is determined in S720 is not whether the current-delivery restriction flag is set but whether the position update flag has been cleared. If the position update flag has been cleared, the process proceeds to S730.

### 2-5. Fifth Embodiment

In the first through fourth embodiments, the control circuit 50 controls the rotation of the motor 30 through the conduction angle control.

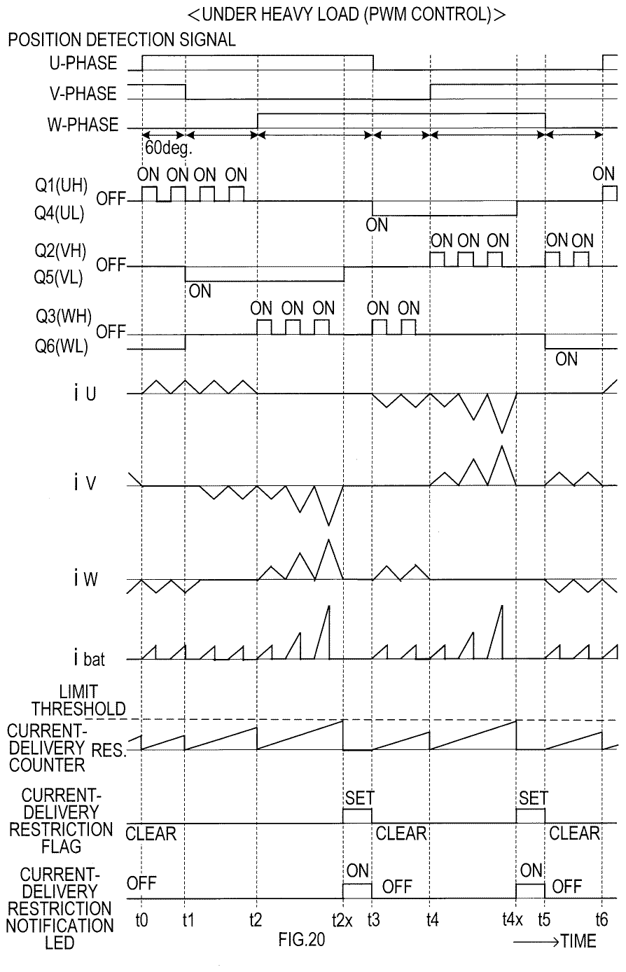

On the other hand, the control circuit 50 of this fifth embodiment controls the motor 30 through the PWM control as shown in FIG. 20. Specifically, in this fifth embodiment, the PWM control is performed as the above-described conduction control, thereby delivering the first electric power to the motor 30. In the PWM control, at least one of the two switches in the driven pair is driven based on a second PWM signal, that is, turned on and off periodically. The second PWM signal has a second duty ratio. The second duty ratio is set such that the actual rotational frequency of the motor 30 is consistent with the desired rotational frequency.

In this fifth embodiment, the current-delivery to the motor 30 is interrupted in response to the actual drive time having reached the limit time, similarly to the first embodiment. That is, the PWM control is stopped. Thus, effects similar to those of the first embodiment can be obtained, too, in this fifth embodiment.

In this fifth embodiment, the “drive ratio” in S860 and S890 in FIG. 12 is replaced with the “second duty ratio”.

That is, in this fifth embodiment too, the control circuit 50 calculates the drive ratio in S860, similarly to the first embodiment. However, the control circuit 50 utilizes this drive ratio as the second duty ratio.

FIG. 20 illustrates that the first restriction process is executed similarly to the first embodiment during a period from when the actual drive time reaches the limit time till when the update timing arrives again (i.e., till when the regular PWM control is resumed). However, during this period, the motor 30 may be controlled similarly to any of the second through fourth embodiments.

### 2-6. Modified Examples

The present disclosure can be implemented in variously modified manners without being limited to the first through fifth embodiments.

In the first through fifth embodiments, the actual drive time is measured by the time counter during the reference control period. When the actual drive time reaches the limit time (i.e., when the first count value reaches the limit threshold), (i) the current-delivery to the motor 30 is restricted, and (ii) the current-delivery restriction notification LED 16 is turned on.

However, the notification through the turning-on of the current-delivery restriction notification LED 16 is not essential. The notification by the current-delivery restriction notification LED 16 may be omitted, and even in such a case, an intended object of the present disclosure can be achieved. Moreover, the notification at the time of the current-delivery restriction and/or the motor lock detection may be performed through another method in place of or in addition to the turning-on of the LED. Specifically, for example, such notification may be performed through display of the information on the display panel 14, generation of an alarm sound, or the like.

The electric work machine 1 of the first through fifth embodiments is in the form of the grass cutter. However, the technique of the present disclosure is applicable to various electric work machines different from the grass cutter, and effects similar to those of the first through fifth embodiments can be obtained. Such various electric work machines may be configured to allow the rotational speed of the motor 30 to be changed according to their work state.

The motor 30 of the first through fifth embodiments is in the form of the three-phase brushless motor including the rotation sensor 32. However, the motor 30 may be a brushless motor other than the three-phase brushless motor, such as a single-phase brushless motor. The motor 30 may be controlled through a so-called sensorless method. Specifically, the motor 30 may include no rotation sensor 32. The rotation angle detection circuit 56 may detect the rotor angle based on induced voltages generated in the first through third windings 30a, 30b, and 30c.

In the first through fifth embodiments, the current-delivery to the motor 30 is controlled through the conduction angle control or the PWM control. However, the motor 30 may be controlled through a combination of the conduction angle control and the PWM control, as in the technique disclosed in Japanese Unexamined Patent Application Publication No. 2023-31617.

### 2-7. Supplemental

Two or more functions of a single element in the first through fifth embodiments may be performed by two or more elements, and a single function of a single element may be performed by two or more elements. Two or more functions performed by two or more elements may be performed by a single element, and a single function performed by two or more elements may be performed by a single element. Part of the configuration in the first through fifth embodiments may be omitted. At least a part of the configuration in one of the first through fifth embodiments may be added to or replace another configuration in the first through fifth embodiments.

The present disclosure can also be embodied in various forms, other than the electric work machine, such as a system including the electric work machine, a program to make a computer function as the electric work machine, a non-transitory tangible recording medium, such as a semiconductor memory, storing the program, and a control method of the electric work machine.

What is claimed is:

1. An electric work machine comprising:
a brushless motor (i) including multiple terminals and (ii) configured to drive a driven tool, the driven tool being fixed to the electric work machine or configured to be detachably attached to the electric work machine;
multiple positive-side conduction paths each electrically coupling a corresponding one of the multiple terminals to a positive electrode of a DC power source;
multiple negative-side conduction paths each electrically coupling a corresponding one of the multiple terminals to a negative electrode of the DC power source;
multiple high-side switches each (i) on a corresponding one of the multiple positive-side conduction paths and (ii) configured to complete or interrupt the corresponding one of the multiple positive-side conduction paths;
multiple low-side switches each (i) on a corresponding one of the multiple negative-side conduction paths and (ii) configured to complete or interrupt the corresponding one of the multiple negative-side conduction paths; and
a control circuit configured to perform:
a conduction control, the conduction control including, each time an update timing arrives, turning on a driven pair corresponding to a rotation angle of the brushless motor according to a first conduction pattern to thereby deliver a first electric power to the brushless motor from the DC power source through the driven pair, the update timing arriving each time the brushless motor rotates by a reference rotation angle, the driven pair including two switches, the two switches being one of the multiple high-side switches and one of the multiple low-side switches, and
a current-delivery restriction, the current-delivery restriction including suspending the conduction control based on occurrence of a first abnormality during performance of the conduction control to thereby restrict or stop delivery of the first electric power to the brushless motor, the first abnormality including elapse of a limit time without arrival of a next update timing since arrival of the update timing.

2. The electric work machine according to claim 1,
wherein the control circuit is configured to resume the conduction control based on arrival of the update timing during performance of the current-delivery restriction.

3. The electric work machine according to claim 1,
wherein the control circuit is configured to resume the conduction control based on elapse of a standby time since start of the current-delivery restriction.

4. The electric work machine according to claim 3,
wherein the control circuit is configured to resume the conduction control based on the standby time having elapsed without arrival of the update timing since the start of the current-delivery restriction.

5. The electric work machine according to claim 1,
wherein the current-delivery restriction includes turning off the multiple high-side switches and the multiple low-side switches to thereby stop delivery of an electric power of the DC power source to the brushless motor.

6. The electric work machine according to claim 1,
wherein the current-delivery restriction includes delivering a second electric power to the brushless motor from the DC power source through the driven pair, the second electric power being smaller than the first electric power.

7. The electric work machine according to claim 6,
wherein the current-delivery restriction includes driving the driven pair according to a second conduction pattern to thereby deliver the second electric power to the brushless motor, the second conduction pattern (i) being different from the first conduction pattern and (ii) including periodically turning on and off at least one of the two switches in the driven pair repeatedly.

8. The electric work machine according to claim 6, further comprising:
a drive circuit (i) including the multiple high-side switches and the multiple low-side switches and (ii) configured to deliver an electric power of the DC power source to the brushless motor,
wherein an amount of heat generated from the drive circuit in response to delivery of the second electric power to the brushless motor is smaller than an amount of heat generated from the drive circuit in response to the delivery of the first electric power to the brushless motor.

9. The electric work machine according to claim 1,
wherein the control circuit is configured to perform a first notification based on start of the current-delivery restriction.

10. The electric work machine according to claim 9,
wherein the control circuit is configured to continue the first notification until the conduction control is resumed, based on the start of the current-delivery restriction.

11. The electric work machine according to claim 10,
wherein the control circuit is configured to stop delivery of an electric power of the DC power source to the brushless motor and perform a second notification based on occurrence of a second abnormality in the electric work machine, the second abnormality being different from the first abnormality, the second notification being different from the first notification.

12. The electric work machine according to claim 11,
wherein the second abnormality includes elapse of a protection determination time without arrival of the update timing since the start of the current-delivery restriction.

13. The electric work machine according to claim 11,
wherein the second abnormality includes rotation of the driven tool being forcibly stopped by an object different from the electric work machine to thereby lock the brushless motor.

14. The electric work machine according to claim 3,
wherein the control circuit is configured to perform a second notification based on a protection determination time having elapsed without arrival of the update timing since the start of the current-delivery restriction, the protection determination time being longer than the standby time.

15. The electric work machine according to claim 1,
wherein the conduction control includes a conduction angle control, the conduction angle control including (i) setting a conduction angle such that a rotational frequency of the brushless motor is consistent with a desired rotational frequency and (ii) maintaining the driven pair to be ON from start of the conduction control until the brushless motor rotates by a rotation angle corresponding to the conduction angle.

16. The electric work machine according to claim 1,
wherein the conduction control includes a PWM control, the PWM control includes (i) setting a duty ratio such that a rotational frequency of the brushless motor is consistent with a desired rotational frequency and (ii) periodically turning on and off at least one of the two switches in the driven pair repeatedly according to the duty ratio.

17. The electric work machine according to claim 1, further comprising:
a rotation angle detector configured to output a position detection signal corresponding to the rotation angle of the brushless motor,
wherein the update timing arrives based on the position detection signal indicating that the brushless motor has rotated by a reference rotation angle.

18. A method for controlling a brushless motor of an electric work machine, the method comprising:
driving a driven pair corresponding to a rotation angle of the brushless motor according to a conduction pattern each time an update timing arrives, the update timing arriving each time the brushless motor rotates by a reference rotation angle, the driven pair including, of multiple switches, two switches corresponding to the rotation angle, the multiple switches each being on a corresponding one of multiple conduction paths electrically coupling the brushless motor to a DC power source; and
suspending driving of the driven pair according to the conduction pattern based on a limit time having elapsed without arrival of a next update timing since arrival of the update timing.
